(19) United States
(12) Patent Application Publication
(10) Pub. No.: US 2006/0050782 A1
(43) Pub. Date: Mar. 9, 2006

(54) Moving picture coding apparatus and coded moving picture editing apparatus generating moving picture data renderable at plural frame rates

(75) Inventors: Naomi Takeda, Kanagawa (JP); Shinichiro Koto, Tokyo (JP); Tomoo Yamakage, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/218,658

(22) Filed: Sep. 6, 2005

(30) Foreign Application Priority Data
Sep. 6, 2004 (JP) 2004-258948

(51) Int. Cl. H04N 11/04; H04N 11/02; H04N 7/12; H04B 1/66

(52) U.S. Cl. 375/240.01

(57) ABSTRACT

A moving picture coding apparatus includes a storing unit that stores an occupancy of a coded picture storing area in which a renderer temporarily stores coded moving picture information received at rendering of the coded moving picture information at a frame rate; a modifying unit that modifies the occupancy based on an amount of the coded moving picture information, and an amount of image data of the coded moving picture information; a deriving unit that derives a condition for the amount of the image data to allow modification at next rendering for each image unit based on a modified occupancy; a setting unit that sets an optimal coding condition of the moving picture information to be coded that satisfies the condition for the amount of the image data; and a coding unit that codes the moving picture information according to the optimal coding condition.

### CROSS-REFERENCE TO RELATED APPLICATIONS

This application is based upon and claims the benefit of priority from the priority Japanese Patent Application No. 2004-258948, filed on Sep. 6, 2004; the entire contents of which are incorporated herein by reference.

### BACKGROUND OF THE INVENTION

1. Field of the Invention

The present invention relates to an apparatus for coding a moving picture and an apparatus for modifying coding information of a moving picture, and more particularly, to a technique to allow rendering of a moving picture at plural frame rates from one piece of coded moving picture data.

2. Description of the Related Art

Conventionally, the NTSC (National Television System Committee) TV delivers an image at a rate of 60 fields per second whereas the PAL (Phase Alteration by Line) TV delivers an image at a rate of 50 fields per second, in other words, there is a difference in the number of fields displayed per second depending on the employed systems. When moving pictures for a film, whose rate is 24 frames per second (fps), is to be edited for the broadcasting on TV, such rate difference needs to be adjusted. Hence, to convert the film image into a moving picture for the NTSC TV, the technique called 3:2 pulldown is adopted. In 3:2 pulldown, three fields are generated from one frame, and then two fields are generated from the next frame, and the process is repeated up to the entire frames, to generate a moving picture of 60 fields per second from a moving picture of 24 frames per seconds (fps). For the PAL TV, the film image is played back faster to achieve a rate of 50 fields per second with 25 frames displayed in one second.

Another conventionally proposed technique suggests encoding and recording the film image at 24 fps on a disk or the like commonly for NTSC and PAL. At rendering of image data as analog signals, 3:2 pulldown is applied for the NSTC, whereas the master clock speed is increased to 25/24 to achieve a rendering rate of 50 fields per second for the PAL (see, Japanese Patent Laid-Open No. 2000-102034, for example). With such a technique, the necessity of distinct coding of the film image for PAL and NTSC is eliminated.

On the other hand, when a high definition digital versatile disk (HDDVD) is rendered with a high definition television (HDTV), coded digital signals do not need to be converted into analog signals and data can be directly rendered using the digital signals. In the HDTV, however, the frame rates for the NTSC and the PAL are different though the image sizes are the same. Hence, in the HDDVD authoring for the generation of the image for the HDDVD, separate generation of an elementary stream is required for each of the NTSC and the PAL.

The generation of the elementary stream of the moving picture with the HDTV size is time-consuming, and the separate generation thereof for the NTSC and the PAL ends up in a massive processing time.

In addition, since a considerable storage capacity is required for the storage of the elementary stream of the moving picture with the HDTV size, separate storage of the elementary streams adjusted for rendering at different frame rates, such as the NTSC and the PAL, requires a large disc space.

### SUMMARY OF THE INVENTION

According to one aspect of the present invention, a moving picture coding apparatus codes moving picture information based on an occupancy of a coded picture storing area in which a renderer temporarily stores coded moving picture information received at rendering of the coded moving picture information at a frame rate. The moving picture coding apparatus includes: a storing unit that stores the occupancy of the coded picture storing area; a modifying unit that modifies the occupancy based on an amount of the coded moving picture information received at the coded picture storing area at rendering, and an amount of image data of the coded moving picture information for each image unit displayed at rendering; a deriving unit that derives a condition for the amount of the image data to allow modification by the modifying unit at a next rendering for each image unit based on a modified occupancy; a setting unit that sets an optimal coding condition of the moving picture information to be coded that satisfies the condition for the amount of the image data; and an coding unit that codes the moving picture information according to the optimal coding condition.

According to another aspect of the present invention, a coded moving picture editing apparatus includes: an inputting unit that receives an input of coded moving picture information, the coded moving picture information being coded according to an optimal coding condition which satisfies a condition on an amount of image data of the coded moving picture information necessary for a display of the image unit at rendering and derived for each of plural frame rates for rendering, and the coded moving picture information including timing information for a display of each image unit at rendering at one of the plural frame rates; a determining unit that determines the frame rate among the plural frame rates other than the frame rate corresponding to the timing information in the coded moving picture information; and a modifying unit that modifies the timing information in the coded moving picture information to the timing information of the determined frame rate.

According to still another aspect of the present invention, moving picture data includes: a structure including identification information for each of plural frame rates for rendering; a structure including moving picture information coded according to an optimal coding condition which satisfies a condition of an amount of image data of the coded moving picture information which is derived for each image unit displayed at rendering and indicates a condition for a necessary amount of the image data for the display of each image unit at a frame rate; and a structure including timing information for each frame rate for display of the moving picture information for each image unit at rendering.

### BRIEF DESCRIPTION OF THE DRAWINGS

FIG. 1 is a block diagram of a structure of a moving picture coding apparatus according to a first embodiment;

FIG. 2 is a block diagram of a structure of a moving picture multiplexing editing apparatus according to the first embodiment;

FIG. 3 is a flowchart of an overall process from reception of target moving picture data up to an output of coded moving picture data in the moving picture coding apparatus according to the first embodiment;

FIG. 4 is a flowchart of an overall process from a modification of timing data for rendering in the PAL inserted into the coded moving picture data to timing data for rendering in the NTSC, up to a multiplexing of the data in the moving picture coding apparatus according to the first embodiment;

FIG. 5A is a diagram of a concept of a bit string of the coded image data for the PAL according to the first embodiment;

FIG. 5B is a diagram of a concept of a bit string of the coded image data for the NTSC generated by the moving picture multiplexing editing apparatus according to the first embodiment;

FIG. 6 is a block diagram of a structure of a moving picture coding apparatus according to a second embodiment;

FIG. 7 is a flowchart of an overall process of reception of target moving picture data up to an output of coded moving picture data in the moving picture coding apparatus according to the second embodiment;

FIG. 8 is a diagram of a transition of buffer occupancy of a receive buffer depending at plural frame rates at rendering of coded moving picture data supplied from the moving picture coding apparatus according to the second embodiment;

FIG. 9 is a diagram of difference in a removal time at a variation-averaged frame rate which is an average of a variable frame rate for rendering in NTSC and a removal time at a frame rate for rendering in NTSC;

FIG. 10 is a graph of difference in transition in a buffer occupancy caused by the difference in the removal time at the variation-averaged frame rate which is an average of the variable frame rate for rendering in NTSC and the removal time at the frame rate for rendering in NTSC;

FIG. 11 is a block diagram of a structure of a moving picture coding apparatus according to a third embodiment;

FIG. 12 is a graph of difference in transition of a buffer occupancy caused by a difference in the removal time at the variation-averaged frame rate which is an average of the variable frame rate for rendering in NTSC and the removal time at the frame rate for rendering in NTSC, when the difference takes a negative value;

FIG. 13 is a flowchart of a process up to calculation of a maximum value of difference in all employable frame rates for rendering by a difference calculating unit of the moving picture coding apparatus according to the third embodiment;

FIG. 14 is a block diagram of a structure of a moving picture coding apparatus according to a fourth embodiment;

FIG. 15A is a diagram of an example of coded moving picture data supplied by the moving picture coding apparatus according to the fourth embodiment;

FIG. 15B is a diagram of an example of coded moving picture data supplied by a moving picture coding apparatus according to a different embodiment from the fourth embodiment;

FIG. 16 is a flowchart of a coding process for each image unit by a moving picture coding apparatus according to a first modification;

FIG. 17 is a graph of transition of a buffer occupancy at the frame rate for PAL and the frame rate for NTSC at rendering of the coded moving picture data coded by a moving picture coding apparatus according to a second modification; and

FIG. 18 is a graph of difference in transition of a buffer occupancy caused by difference in the removal time at the variation-averaged frame rate which is an average of the variable frame rate for rendering in NTSC and the removal time at the frame rate for rendering in NTSC, when the difference takes a positive value.

### DETAILED DESCRIPTION OF THE PREFERRED EMBODIMENTS

In the following a moving picture coding apparatus and a moving picture multiplexing editing apparatus according to a first embodiment is described. The moving picture coding apparatus is suitable for the rate control with a constant bit rate (CBR) on data conversion, and the moving picture multiplexing editing apparatus multiplexes the moving picture data coded by the moving picture coding apparatus. It should be noted that the CBR is merely an example of the rate control and a variable bit rate (VBR) is also employable in the moving picture coding apparatus.

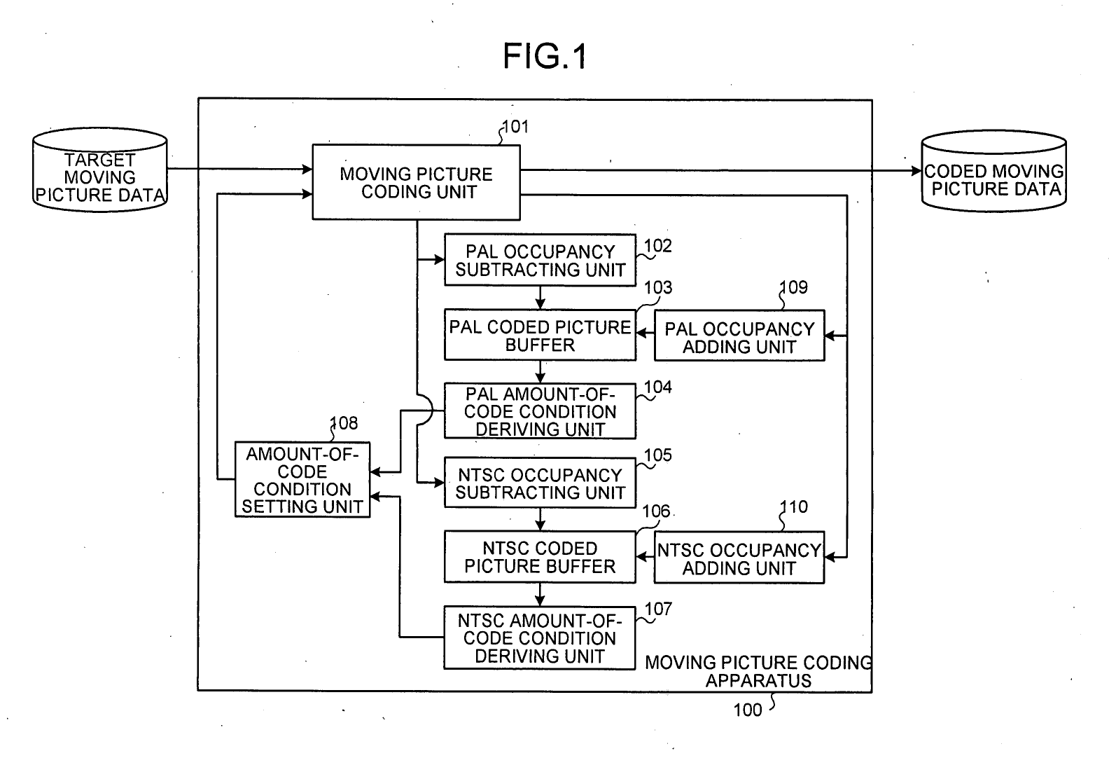

FIG. 1 is a block diagram of a structure of the moving picture coding apparatus according to the first embodiment. The moving picture coding apparatus 100 includes a moving picture coding unit 101, a PAL occupancy adding unit 109, a PAL occupancy subtracting unit 102, a PAL coded picture buffer 103, PAL amount-of-code condition deriving unit 104, an NTSC occupancy adding unit 110, an NTSC occupancy subtracting unit 105, an NTSC coded picture buffer 106, an NTSC amount-of-code condition deriving unit 107, and a amount-of-code condition setting unit 108. The moving picture coding apparatus 100 with the above-described structure is capable of generating coded moving picture data as an output from target moving picture data received as an input so that neither underflow nor overflow occurs regardless of an employed rendering system, i.e., PAL or NTSC.

The coded moving picture data output from the moving picture coding apparatus 100 includes timing data for rendering in PAL. Hence, the timing data must be changed for rendering in NTSC. The moving picture multiplexing editing apparatus which modifies the timing data for rendering in NTSC is described later. Here, the timing data set in the coded moving picture data does not need to be previously adjusted for rendering in PAL, and alternatively, the timing data for rendering in NTSC may be inserted.

The moving picture coding unit 101 codes target moving picture data supplied as an input following a coding condition set by the amount-of-code condition setting unit 108 described later, and supplies coded moving picture data as an output. A coding format of the moving picture in the first embodiment follows H.264, though not limited thereto. Alternatively, any coding format, such as MPEG2, is applicable.

The coded moving picture data for NTSC and the coded moving picture data for PAL may have timing data of different sizes (e.g.;, in particular, the code length of bit_rate_value_minus1 information described later). Hence, the moving picture coding unit 101 determines the size of an area allocated for the timing data (e.g., sequence parameter SET RBSP or the like described later) depending on the size of the larger timing data. In the first embodiment, since the timing data for NTSC requires a larger area, the area of the timing data for PAL is determined depending thereon. The moving picture coding unit 101 performs zero-stuffing on an unused area at the coding. Specific size difference is described later.

The area size of the timing data is not determined exclusively for NTSC and PAL. A sufficient area must be secured for the timing data of various frame rates to be employed for rendering.

The PAL coded picture buffer 103 virtually realizes a receive buffer to be employed at rendering coded moving picture with a renderer such as an HDDVD player in PAL, and stores a capacity of the receive buffer usable for data storage and a required amount of buffer capacity (buffer occupancy) for rendering of coded moving picture data supplied from the moving picture coding unit 101.

The PAL occupancy adding unit 109 adds an amount of increase in buffer occupancy from a timing of removal of a picture k−1 to a timing of removal of a picture k according to a bit rate set for the PAL to the PAL coded picture buffer 103.

The PAL occupancy subtracting unit 102 subtracts an amount of generated bits of the picture k at the coding of the target moving picture data by the moving picture coding unit 101 from the buffer occupancy stored in the PAL coded picture buffer 103 at the removal time of the picture k at the frame rate of PAL. Here, k is an integer equal to or larger than zero and corresponds to the number of pictures in the target moving picture data supplied as an input.

The PAL amount-of-code condition deriving unit 104 derives a condition applied to the generated bit of the picture k supplied from the moving picture coding unit 101 so that the coded moving picture data supplied from the moving picture coding unit 101 does not cause overflow at the receive buffer for PAL virtually realized by the PAL coded picture buffer 103 nor cause underflow due to the subtraction of the buffer occupancy in the PAL coded picture buffer 103 by the PAL occupancy subtracting unit 102.

The NTSC coded picture buffer 106 virtually realizes a receive buffer employed for rendering coded moving picture with a renderer such as an HDDVD player in NTSC, and stores a capacity of the receive buffer usable for data storage and buffer occupancy of the receive buffer at rendering of coded moving picture data supplied from the moving picture coding unit 101.

The NTSC occupancy adding unit 110 adds an increase in the buffer occupancy from the removal time of the picture k−1 to the removal time of the picture k according to a bit rate set for NTSC to the NTSC coded picture buffer 106.

The NTSC occupancy subtracting unit 105 subtracts the amount of the generated bits of the picture k at the coding of the target moving picture data by the moving picture coding unit 101 from the buffer occupancy stored in the NTSC coded picture buffer 106 at the removal time of the picture k at the frame rate for NTSC.

For image rendering in the NTSC, 3:2 pulldown is performed on the target moving picture data, in other words, three fields are generated from a first frame, two fields are generated from a second frame, three fields are generated from a third frame, and two fields are generated from a fourth frame, and the processing continues up to the last frame. Hence, the NTSC occupancy subtracting unit 105 sets the removal time for the units of three fields, two fields, three fields, two fields, and so on.

3:2 pulldown may be performed by other process. For example, a process that two fields are generated from a first frame, three fields are generated from a second frame, two fields are generated from a third frame, and the processing continues up to the last frame, may be performed. Moreover, 3:2 pulldown may be performed by a process depending on characteristics of the moving picture, e.g., three fields, three fields, three fields, two fields, and two fields are sequentially generated.

The NTSC amount-of-code condition deriving unit 107 derives a condition of the generated bit of the picture k supplied from the moving picture coding unit 101 so that the coded moving picture data supplied from the moving picture coding unit 101 does not cause overflow at the receive buffer for NTSC realized by the NTSC coded picture buffer 106, not cause underflow due to the subtraction of the occupancy of the NTSC coded picture buffer 106 by the NTSC occupancy subtracting unit 105.

The amount-of-code condition setting unit 108 derives a condition for the generated bit of the picture k coded by the moving picture coding unit 101 so as to satisfy the condition of the generated bit of the coded moving picture data derived by the PAL amount-of-code condition deriving unit 104 and the condition of the generated bit of the coded moving picture data derived by the NTSC amount-of-code condition deriving unit 107, and sets a coding condition such as information on quantization value, information on coding mode selection that affects the amount-of-code, to control the amount of generated bit in accordance with the condition. With such a procedure, the condition can be set so as to prevent the occurrence of underflow and overflow in PAL and NTSC.

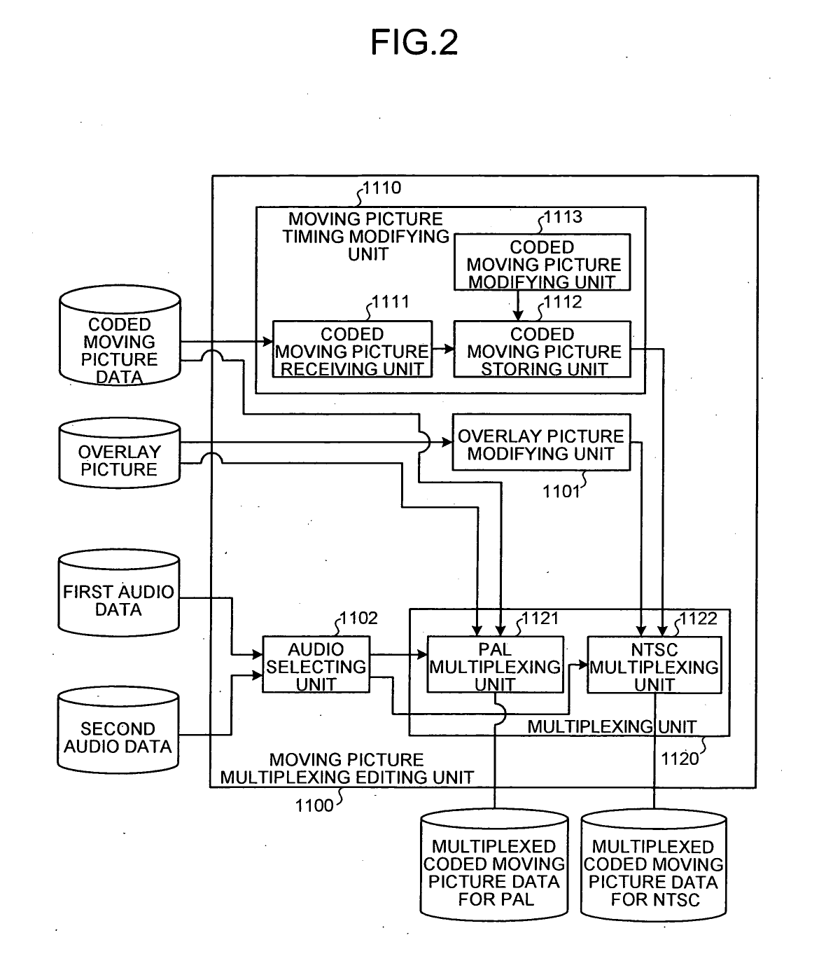

FIG. 2 is a block diagram of a structure of the moving picture multiplexing editing apparatus 1100 according to the first embodiment. The moving picture multiplexing editing apparatus of the first embodiment performs insertion or correction of the timing data for a decoding timing or a display timing to allow rendering of coded moving picture data, which is coded as to be renderable at various frame rates by the moving picture coding apparatus 100, at a desirable frame rate, performs insertion or correction of the timing data for synchronization of a supplied overlay picture and the coded moving picture data, and selects necessary audio data for rendering at the desirable frame rate from plural pieces of audio data, to perform multiplexing.

The moving picture timing modifying unit 1110 carries out modification to allow rendering at a desirable frame rate of the coded moving picture data which is renderable at plural frame rates. The moving picture timing modifying unit 1110 includes a coded moving picture receiving unit 1111, a coded moving picture storing unit 1112, and a coded moving picture modifying unit 1113.

The coded moving picture receiving unit 1111 receives coded moving picture data which is renderable at plural frame rates and generated by the moving picture coding apparatus 100.

The coded moving picture storing unit 1112 stores the coded moving picture data supplied from the coded moving picture receiving unit 1111.

The coded moving picture modifying unit 1113 modifies the coded moving picture stored in the coded moving picture storing unit 1112 to allow rendering at a desirable frame rate. In the first embodiment, the coded moving picture data supplied by the moving picture coding apparatus 100 includes a timing data set for rendering in PAL. Hence, the timing data is modified for rendering in NTSC. Here, the timing data may be modified as suitable for any frame rate for rendering of the coded moving picture data and the modification to the timing data for NTSC is not a limiting example.

The coded moving picture modifying unit 1113 recalculates the timing data such as a time the removal of a first picture starts, and a removal time of each picture, representing the time the data reception starts as zero, in accordance with the bit rate, the frame rate, and the amount of an initial buffer occupancy, and modifies a pertinent portion of the coded moving picture data according to the result of recalculation. The value to be modified is described later. Here, since the moving picture data is coded as to allow rendering in plural frame rates, the moving picture data itself is not re-coded.

The coded moving picture modifying unit 1113 performs correction according to the coding format of H.264. The coding format is not limited to H.264 and any other coding format may be adoptable.

An overlay picture modifying unit 1101 modifies a portion of the timing data to allow rendering of the overlay picture at a desirable frame rate. In the first embodiment, the overlay picture is assumed to include an inserted timing data for rendering in PAL and the modification is performed for rendering in NTSC. Here, the manner of modification of the timing data is not limited, and in the first embodiment, a conventional modification technique is employed.

An audio selecting unit 1102 selects audio data corresponding to a desired frame rate from plural pieces of audio data corresponding respectively to plural frame rates. For example, audio data for PAL (hereinafter also referred to as “first audio data”) is supplied to a PAL multiplexing unit 1121 described later, whereas audio data for NTSC (also referred to as second audio data hereinbelow) is supplied to an NTSC multiplexing unit 1122 described later.

The multiplexing unit 1120 multiplexes coded moving picture data, an overlay picture, each modified as suitable for rendering at a desired frame rate, and selected audio data, to generate coded video data. The multiplexing unit 1120 includes the PAL multiplexing unit 1121 and the NTSC multiplexing unit 1122. Here, the process performed by the multiplexing unit 1120 is not limited to the multiplexing of moving picture data for NTSC and PAL, and multiplexing for any frame rate may be performed. In addition, the multiplexing is not limited to the multiplexing for two frame rates and the multiplexing for any number of frame rates, for example, for one frame rate or more than two frame rates, may be performed.

The medium to store the generated video data is not specifically limited. Any medium, such as an HDDVD or a blu-ray disc may be applicable.

The moving picture multiplexing editing apparatus 1100 allows modification and multiplexing of the timing data at a target frame rate for coded moving picture data coded by the moving picture coding apparatus 100.

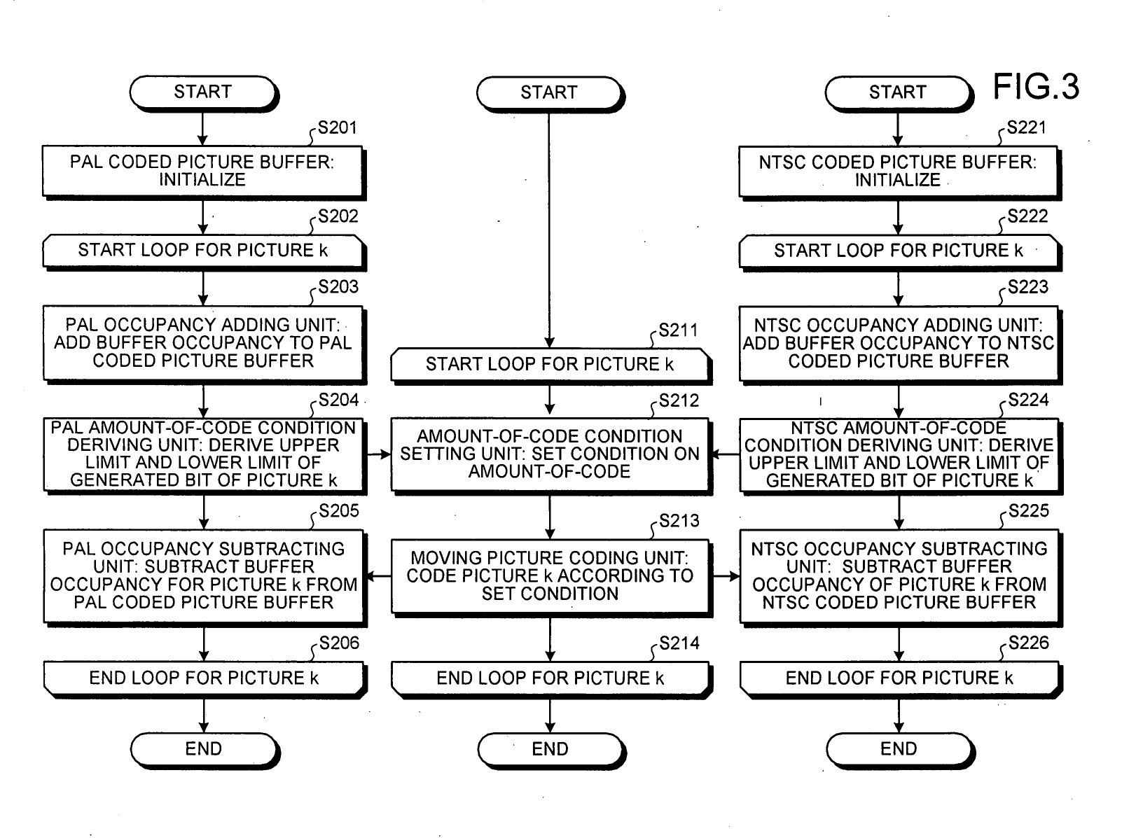

Next, a process by the moving picture coding apparatus 100 is described in which coded moving picture data is generated from target moving picture data supplied as an input so that rendering thereof in both PAL and NTSC does not cause overflow or underflow. FIG. 3 is a flowchart of an overall process in the moving picture coding apparatus 100 according to the first embodiment for generating coded moving picture data from target moving picture data supplied as an input.

First, the PAL coded picture buffer 103 is initialized (step S201). Specifically, an initial occupancy of the buffer (this constant is indicated as “initial_cpb_occupancy” hereinafter) is supplied as a buffer occupancy by the coded moving picture data stored in the PAL coded picture buffer 103 (the variant stored in the PAL coded picture buffer 103 is indicated as “pal cpb_occupancy(k)” hereinbelow) as represented by Expression (1):
pal_cpb_occupancy(−1)=initial_cpb_occupancy (1)

Here, the initial value is represented as equivalent to pal_cpb_occupancy(−1), since the pictures are represented with the variant “k” where k represents an integer equal to or larger than zero.

The process from step S203 to step S205 is performed as a loop until the completion of coding of all pictures (picture k, where k increments from zero) contained in the coded moving picture data (step S202).

The PAL occupancy adding unit 109 adds an increase in the buffer occupancy from the removal time of the picture k−1 to the removal time of the picture k corresponding to the bit rate set for PAL (step S203). Specifically the process is performed according to Expression (2):
pal_cpb_occupancy(k)=pal_cpb_occupancy(k−1)+pal_bit_rate×{(removal time of picture k at frame rate for PAL)−(removal time of picture k−1 at frame rate for PAL)} (2)

It should be noted that for the picture 0 (i.e., when k=0), the removal time of the picture k−1 at the frame rate for PAL and the removal time of the picture k at the frame rate for PAL are assumed to be the same and the calculation of Expression (2) is performed based on the assumption.

The PAL amount-of-code condition deriving unit 104 calculates an upper limit (pcb_max_bits) of the generated bit amount of the picture k to prevent underflow in the PAL coded picture buffer 103 immediately after the removal of the picture k, and calculates a lower limit (pcb_min_bits) of the generated bit amount of the picture k to prevent overflow in the PAL coded picture buffer 103 immediately after the removal of the picture k+1, and outputs the results to the amount-of-code condition setting unit 108 (step S204).

The PAL occupancy subtracting unit 105 subtracts the generated bit amount of the picture k supplied by the moving picture coding unit 101 in step S213 described later from the buffer occupancy of the PAL coded picture buffer 103 (step S205). Specifically, the process of step S205 is performed according to Expression (3):
pal_cpb_occupancy(k)=pal_cpb_occupancy(k)−(generated bit of picture k) (3)

After the completion of the subtraction of the generated bit in step S205, the process returns to step S203 (step S206). When all the pictures contained in the target moving picture data are coded, the process finishes.

The process for NTSC, similarly to steps S201-S206 of the process for PAL, starts from the initialization of the NTSC coded picture buffer 106, performs a process as a loop for every picture k, the process includes: adding the buffer occupancy for every picture k; calculating an upper limit (ntsc_max_bits) and a lower limit (ntsc_min_bits) of the generated bit amount for every picture k; and subtracting the generated bit amount of the picture k from the buffer occupancy of the NTSC coded picture buffer 106 (steps S221-S226). Here, the initial value to be set in step S221 as the buffer occupancy (hereinafter the variant is referred to as ntsc_cpb_occupancy(k)) of the coded moving picture data by the NTSC coded picture buffer 106 is referred to as initial_cpb_occupancy similarly to step S201.

An amount to be added in step S223 as the increased amount of buffer occupancy of the NTSC coded picture buffer 106 by the NTSC occupancy adding unit 109 is calculated according to Expression (4):
ntsc_cpb_occupancy(k)=ntsc_cpb_occupancy(k−1)+ntsc_bit_ratex×{(removal time of picture k at frame rate for NTSC)−(removal time of picture k−1 at frame rate for NTSC)} (4)

Since 3:2 pulldown is performed in the conversion for NTSC, the value of “(removal time of picture k at frame rate for NTSC)−(removal time of picture k−1 at frame rate for NTSC)” may vary depending on the value of k.

Further, an amount to be subtracted from the buffer occupancy of the NTSC coded picture buffer 106 in step S225 is calculated according to the following Expression (5). The generated bit amount of the picture k is of course same with that in Expression (3).
ntsc_cpb_occupancy(k)=ntsc_cpb_occupancy(k)−(generated bit of picture k) (5)

The processes performed in the amount-of-code condition setting unit 108 and the moving picture coding unit 101 are also performed as a loop for the picture k (k is equal to or larger than zero) until the coding for all pictures in the target moving picture data finishes (step S211).

The amount-of-code condition setting unit 108 sets the coding condition so as to satisfy the conditions concerning the upper limit and the lower limit of the generated bit of the picture k for PAL supplied in step S204, and the upper limit and the lower limit of the generated bit of the picture k for NTSC supplied in step S224 (step S212).

First, an upper limit of the generated bit satisfying the conditions in both PAL and NTSC is calculated according to Expression (6):
max_bits=min(pal_max_bits, ntsc_max_bits) (6)

Next, a lower limit of the generated bit satisfying the conditions in both PAL and NTSC is calculated according to Expression (7):
min_bits=max(pal_min_bits, ntsc_min_bits) (7)

Then, the amount-of-code condition setting unit 108 sets the coding condition such as information on quantization value which satisfies the following Expression (8) for max_bits and min_bits calculated based on Expressions (6) and (7), and outputs the result to the moving picture coding unit 101.
min_bits≦generated bit amount of picture k≦max_bits (8)

The moving picture coding unit 101 codes data of picture k so as to satisfy the supplied coding condition (step S213). Further, the moving picture coding unit 101 supplies the generated bit amount of picture k to the PAL occupancy subtracting unit 102 and the NTSC occupancy subtracting unit 105.

After the completion of the coding of picture k in step S213, the process returns to the beginning of the loop, i.e., S211 (step S214). The process finishes when all the pictures contained in the target moving picture data are coded.

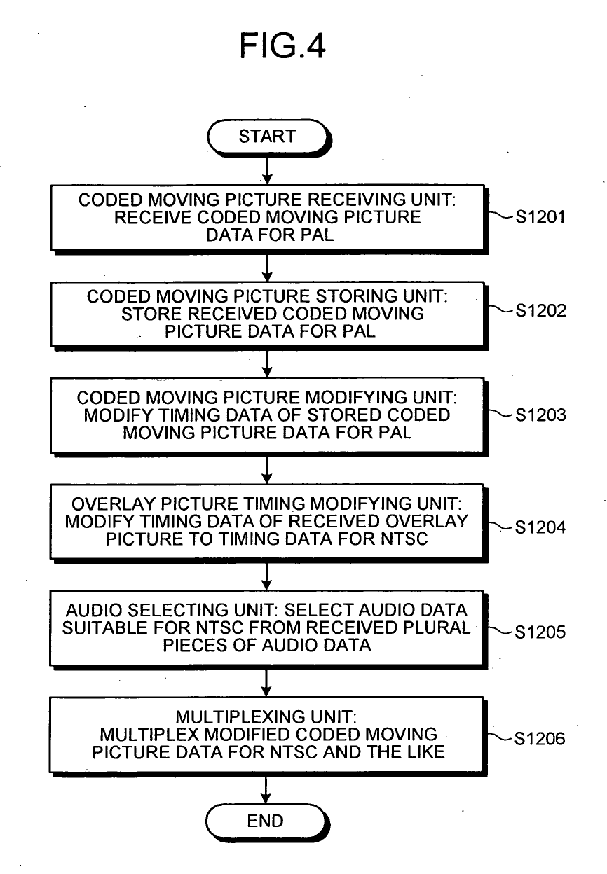

Next, a process of the moving picture multiplexing editing apparatus 1100 according to the first embodiment with the above-described structure is described, in which the moving picture multiplexing editing apparatus 1100 modifies the timing data of the coded moving picture data set for rendering in PAL into the timing data for rendering in NTSC, and performs multiplexing. FIG. 4 is a flowchart of an overall process of modification of the timing data for rendering in PAL in the coded moving picture data supplied from the moving picture coding apparatus 100 into the timing data for rendering in NTSC, and multiplexing.

Here, the multiplexing for rendering of the coded moving picture data in PAL in the moving picture multiplexing editing apparatus 1100 is not described since the process is similar to a conventionally known process.

First, the coded moving picture receiving unit 1111 receives coded moving picture data with inserted timing data for PAL (step S1201).

Then, the coded moving picture storing unit 1112 stores the coded moving picture data supplied from the coded moving picture receiving unit 1111 (step S1202).

The coded moving picture modifying unit 1113 modifies the timing data for PAL in the coded moving picture data stored in the coded moving picture storing unit 1112 into the timing data for NTSC (step S1203). The modification of the timing data is specifically described below.

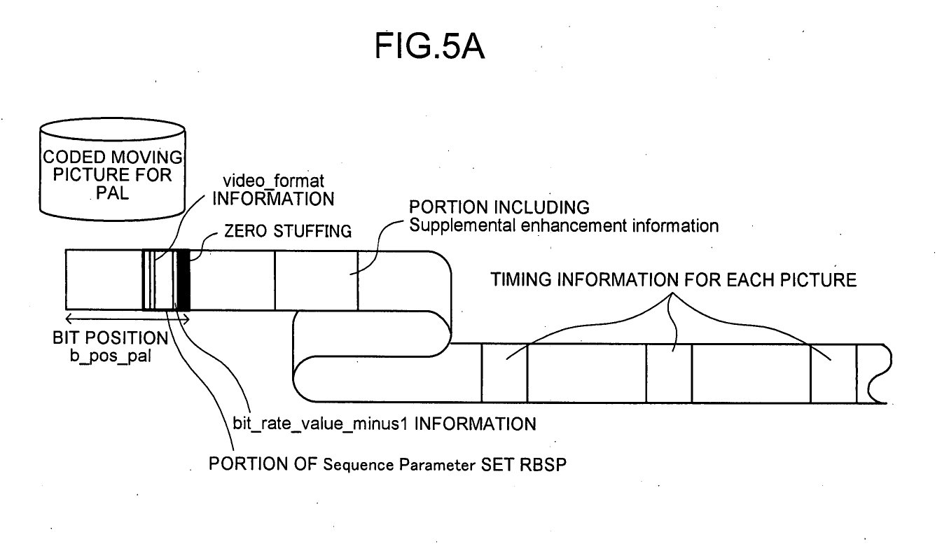

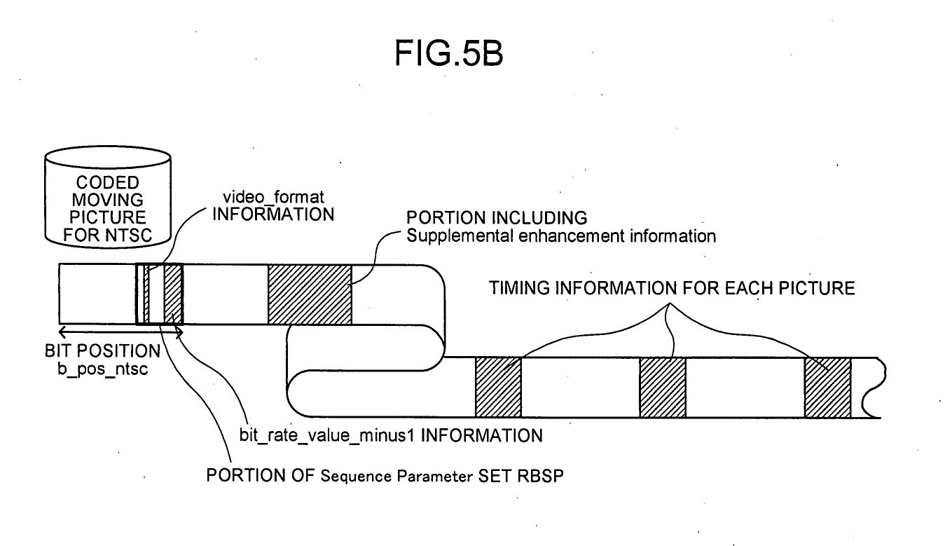

FIG. 5A is a schematic diagram of a bit string of the coded image data for PAL. Storage location in the bit string is shown as a belt for convenience in FIG. 5A, though the shape shown in FIG. 5A does not represent an actual shape of the recording medium. Here, the coded image data for PAL means moving picture data which can be rendered in PAL.

FIG. 5B is a schematic diagram of a bit string of NTSC coded image data generated by the moving picture multiplexing editing apparatus 1100 according to the first embodiment. Similarly to FIG. 5A, the shape shown in FIG. 5B does not represent the shape of an actual recording medium. Shaded areas in FIG. 5B are areas where the timing information or the like modified by the coded moving picture modifying unit 1113 is stored.

The coded moving picture modifying unit 1113 corrects the timing data for PAL of the PAL coded image data shown in FIG. 5A into the timing data for NTSC, to generate the NTSC coded image data shown in FIG. 5B from the PAL coded image data.

A portion of the timing data corrected by the coded moving picture modifying unit 1113 is described below, first a portion to be corrected for each sequence and then a portion to be corrected for each picture.

The coded moving picture modifying unit 1113, as a correction for each sequence, corrects video usability information which is data to be utilized at the use of the coded image. When video_format information in vui_parameters of sequence parameter SET RBSP needs to be corrected, the coded moving picture modifying unit 1113 determines whether the video format is PAL, NTSC, SECAM, or MAC, and describes an appropriate identifier.

A distinct identifier may be defined for HDTV of PAL and NTSC, however, as far as the identifier is different in PAL from NTSC, any newly-defined identifier is adoptable.

The coded moving picture modifying unit 1113 corrects video_format information of the PAL coded image data to generate the NTSC coded image data from the PAL coded image data.

The coded moving picture modifying unit 1113 modifies the description of bit rate information in vui_parameters of sequence parameter SET RBSP. The description of bit rate information is represented by the bit_rate_value_minus1 and bit_rate_scale in hrd_parameters of vui_parameters. The manner of setting the description varies according to the type of H.264 buffering model. For example when the variable bit rate (VBR) is adopted, a maximum bit rate is commonly set for both NTSC and PAL, hence the modification of the description is not necessary. On the other hand, when the constant bit rate (CBR) is adopted, the bit rate is set to the same rate with the frame rate.

Specifically, bit rates for PAL where the frame rate is 25 fps and for NTSC where the frame rate is 24 fps can be set according to Expressions (9) and (10):
25×2\hat{0}((6+bit_rate_scale)×N) (9)
24×2\hat{0}((6+bit_rate_scale)×N) (10)

Here, when bit_rate_scale=0 and N=7500, the bit rate for PAL is 12 Mbps whereas the bit rate for NTSC is 11.52 Mbps. With these bit rates, the value of bit_rate_value_minus 1 can be found according to Expressions (11) and (12):
25×2\hat{0}N−1 (11)
24×2\hat{0}N−1 (12)

When the frame rates are 25 fps and 23.967 fps for each, the bit rates can be found according to Expressions (13) and (14), and when bit_rate_scale=0 and N=187, bit_rate_value_minus1 can be obtained as represented by Expressions (15) and (16):
1001×2\hat{0}((6+bit_rate_scale)×N) (13)
960×2\hat{0}((6+bit_rate_scale)×N) (14)
1000×2\hat{0}N−1 (15)
960×2\hat{0}N−1 (16)

Next, the reason why the zero-stuffing is performed for the timing data area at the coding by the moving picture coding apparatus 100 is described in detail, though different from an order of the process shown in FIG. 4. When the CBR is employed, the context of bit_rate_value_minus1 is different for each frame rate, hence code lengths of the results of coding may be different. For example, when the bit rate of the coded moving picture is 11.52 Mbps and rendering rate is 24 fps, the description of bit_rate_value_minus1 of the bit rate information of the coded moving picture data includes a coded bit string of Expression (16). For the correction of the coded moving picture data as to be suitable for rendering rate of 25 fps, the coded bit string of Expression (16) is replaced with a bit string obtained by coding by Expression (15).

Here, if the bit string obtained by coding of Expression (15) is longer than the bit string obtained by coding of Expression (16), and the zero-stuffing is not performed, the bit position of the coded moving picture data shifts in the context after the portion of bit_rate_value_minus1. In other words, the data subsequent to bit_rate_value_minus1 shifts by the length of bit_rate_value_minus1 in the NTSC coded moving picture data compared with the PAL coded moving picture data.

Then, the editing of the subsequent coded information must be performed in view of the shift in bit position. Here, the total bit amount of the eventually obtained coded information may exceed the limit of the storage capacity. Hence in the embodiment, a sufficient amount of the storage is secured in view of the possible correction of the size of the coded data including the timing data, and zero-stuffing is performed on an unused region.

Return to step S1203 of FIG. 4, the coded moving picture modifying unit 1113 modifies the description of time_scale and num_units_in_tick included in vui_parameters of sequence parameter SET RBSP and represent the data frame rate. In the first embodiment, though the code lengths of time_scale and num_units_in_tick are same, actually set values are modified according to the frame rate and the 3:2 pulldown.

Specifically, when frame rate is 25 fps as in PAL, time_scale is 25 and num_units in tick is 1, whereas when frame rate is 23.976 fps as in NTSC and the 3:2 pulldown is performed explicitly at the time of display, time_scale is 60000 and num_units in tick is 1001. Here, when the 3:2 pulldown is automatic, time_scale is 24000 and num_units_in_tick is 1001. On the other hand, when the explicit 3:2 pulldown is performed in NTSC where the frame rate is 24 fps, time_scale is 30 and num_units_in_tick is 1, whereas when the automatic 3:2 pulldown is performed, time_scale is 24 and num_units_in_tick is 1.

Next for each sequence, the coded moving picture modifying unit 1113 corrects supplemental enhancement information message which is data to be utilized at decoding and drawing.

Specifically, the coded moving picture modifying unit 1113 corrects initial_cpb_removal_delay and initial_cpb_removal_delay_offset in buffering_period_SEI which is timing information for a time period starting from the reception of the coded moving picture up to the display of a first picture. The code lengths of these are determined by hrd_parameters in vui_parameters of sequence parameter SET RBSP, and hence of a same size for NTSC and PAL. The values, however, are set to be different corresponding to the bit rates so that the buffer occupancy of the receive buffer is same in NTSC and PAL. Specifically, when the buffer occupancy is represented as buffer_occupancy and the buffer size is represented as buffer_size, initial_cpb_removal_delay and initial_cpb_removal_delay_offset of the PAL are represented by the following Expressions (17) and (18) whereas the corresponding values of the NTSC are represented by the following Expressions (19) and (20).
initial_cpb_removal_delay=buffer_occupancy/bit_rate_for_pal (17)
initial_cpb_removal_delay_offset=buffer_size/bit_rate_for_pal-initial_cpb_removal_delay (18)
initial_cpb_removal_delay=buffer_occupancy/bit_rate_for_ntsc (19)
initial_cpb_removal_delay_offset=buffer_size/bit_rate_for_ntsc-initial cpb removal_delay (20)

The coded moving picture modifying unit 1113 further corrects the coded moving picture data for each picture.

First, the coded moving picture modifying unit 1113 corrects a portion of the data including a description on a delay time required at the decoding and drawing for process transition from one picture to another. Specifically, when the explicit 3:2 pulldown is not performed, cpb_removal_delay (corresponding to DTS) and dpb_output_delay (corresponding to PTS) of pic_timing_SEI are set to same values for NTSC and PAL, whereas when the explicit 3:2 pulldown is performed, different values are set for NTSC and PAL.

Specifically, for PAL, cpb_removal_delay and dpb_output_delay are set to one (1) for all pictures, whereas for NTSC for which the explicit 3:2 pulldown (pattern of three fields, two fields, three fields, two fields) is adopted, the value of cpb_removal_delay is corrected for each picture as described below. Specifically, cpb_removal_delay for the picture 0 is zero, for the picture 1 is three, for the picture 2 is two, for the picture 3 is three, and for the picture 4 is two, and the same follows.

Next, the coded moving picture modifying unit 1113 corrects pic_struct of pic_timing_SEI for each picture. The portion pic_struct indicates a manner of picture display, and when the explicit 3:2 pulldown display is not employed, pic_struct specifies a frame display. When the explicit pulldown display is employed, a display manner is specified for each picture, i.e., one of (three-field display in the order of top field, bottom field, and top field), (three-field display in the order of bottom field, top field, and bottom field), (two-field display in the order of top field and bottom field), and (two-field display in the order of bottom field and top field) is specified.

The coded moving picture modifying unit 1113 further modifies each piece of time stamp information of pic_timing_SEI as necessary. Though not adopted in the process here, when the code length of pic_timing_SEI is different in NTSC and PAL, similarly to the correction for each sequence described above, the size may be determined according to the longer code length for each byte_stream_nal_units( ) in the moving picture coding unit 101 of the moving picture coding apparatus 100, and zero-stuffing is performed on an unused area at the coding by a moving picture generating apparatus.

Thus, the coded moving picture modifying unit 1113 finishes the modification of the timing data and a next process starts.

The overlay picture modifying unit 1101 modifies the timing data to allow rendering in NTSC of the overlay picture which is set for the display in PAL (step S1204).

Further, the audio selecting unit selects audio data appropriate for rendering in NTSC from plural pieces of audio data supplied as inputs (step S1205).

With the process as described above, the coded moving picture data which is renderable at various frame rates can be modified into coded moving picture data which is producible at a certain frame rate simply with the correction of the timing information without the re-coding of video signals. Thus, the coded moving picture data which is renderable at a certain frame rate can be generated easily and at a high-speed from one piece of coded moving picture data which is usable at various frame rates.

According to the process as described above, the moving picture multiplexing editing apparatus 1100 corrects the timing data (video_format information and bit_rate_value_minus1 information) in the coded moving picture obtained by the moving picture coding apparatus 100. In the first embodiment, zero-stuffing is performed on the timing data. Hence, the shift in the bit position following the sequence parameter SET RBSP does not occur due to the size difference and the size of the coded moving picture data does not change before and after the modification. Thus, simple modification is allowed.

Further, multiplexing of the coded moving picture data with modified timing data is allowed.

Still further, when zero-stuffing is not performed in the moving picture coding apparatus 100 and the moving picture multiplexing editing apparatus 1100 performs modification in view of the change in the amount-of-code, the size of the amount-of-code of the coded moving picture data varies before and after the modification. Hence, inconvenience might arise, for example, the recording on the medium such as an HDDVD cannot be performed due to the change in the size of the amount-of-code of the coded moving picture data. However, in the first embodiment, since the moving picture coding apparatus 100 performs the zero-stuffing, the change in the size of the amount-of-code does not need to be taken into consideration.

In the first embodiment, the moving picture coding apparatus 100 conducts the coding for rendering rate in PAL, and the moving picture multiplexing editing apparatus 100 modifies the coded moving picture data for rendering in NTSC. However, the initial coding may be performed according to rendering rate in NTSC and modification may be performed afterwards for rendering in PAL. When the process is modified in this manner, the moving picture coding apparatus 100 nonetheless determines the size of an area for the timing data as described above before the coding. Then, the moving picture multiplexing editing apparatus 1100 performs zero-stuffing on a portion in the timing data area which remains unused at the modification of the timing data (video_format information and bit_rate_value_minus1 information).

The first embodiment does not intend to limit the present invention to the application for the data modification between NTSC and PAL and the present invention is applicable to the modification for other bit rate.

Since the moving picture multiplexing editing apparatus 1100 according to the first embodiment allows the generation of content for each of plural frame rates from one piece of coded moving picture data, reduction in coding costs and reduction in storage capacity required for the storage of contents can be realized.

Further, the present invention is not limited to the modification of the coded moving picture data for PAL generated by the moving picture coding apparatus 100 into the coded moving picture data for NTSC by the moving picture multiplexing editing apparatus 1100. For example, the coded moving picture data for NTSC generated by the moving picture coding apparatus 100 may be converted into the coding moving picture data for PAL, where the coded moving picture modifying unit 1113 modifies the timing data of the coded moving picture data for NTSC. Thus, the present invention is similarly applicable to any modification of timing data among employable frame rates for image rendering.

Here, the embodiment does not intend to limit the employable plural frame rates for rendering to the frame rates for PAL and NTSC. For example, a coded picture buffer, an occupancy adding unit, an occupancy subtracting unit, and a amount-of-code condition deriving unit may be provided for each different frame rate such as SECAM and MAC, and a coding condition may be set by the amount-of-code condition setting unit 108 so as to satisfy the condition of the amount-of-code of each frame rate.

In the first embodiment, the description is given on the structure and the process sequence applied to the frame rates for PAL and NTSC. The embodiment, however, does not intend to limit the number of employable frame rates to two, and more than two frame rates can be used.

Further, the present invention is similarly applicable where the frame rate is converted according to a technique other than 3:2 pulldown for NTSC. Then, the interval between the times of removal of the pictures varies depending on a picture number. Such variation can be dealt with by the similar process sequence as the process described above for NTSC.

Further, since the apparatus according to the first embodiment conducts coding by setting the condition on the amount-of-code to prevent underflow and overflow at each receive buffer at any employable frame rate for rendering, to control a amount-of-code of picture k, the coded moving picture can be utilized at various frame rates. Thus, the processing time for coding and the disc space required for coding can be reduced compared with those in an apparatus which conducts coding for each of various frame rates.

Still further, the first embodiment is realized with the moving picture coding apparatus 100 that performs coding and the moving picture multiplexing editing apparatus that performs modification and multiplexing of the timing data as separate apparatuses. However, the moving picture coding apparatus and the moving picture multiplexing editing apparatus may be realized as one apparatus which receives target moving picture data and outputs plural pieces of coded moving picture data multiplexed for each of plural frame rates.

Next, a moving picture coding apparatus 300 suitable for a rate control by VBR at data conversion according to a second embodiment is described. The moving picture coding apparatus 300, to allow the use of one piece of coded moving picture data at various frame rates, selects a highest frame rate among plural frame rates, and controls the amount-of-code to prevent underflow at a coded picture buffer for the selected frame rate. In the second embodiment, peak rates of the plural frame rates are assumed to be the same. Then, the buffer occupancy of the highest frame rate does not exceed the buffer occupancy of other frame rates, whereby the consideration of only the highest frame rate suffices.

A moving picture multiplexing editing apparatus that multiplexes the coded moving picture data generated by the moving picture coding apparatus 300 includes same components as the components of the moving picture multiplexing editing apparatus 1100 described according to the first embodiment. Hence, the description thereof is not repeated.

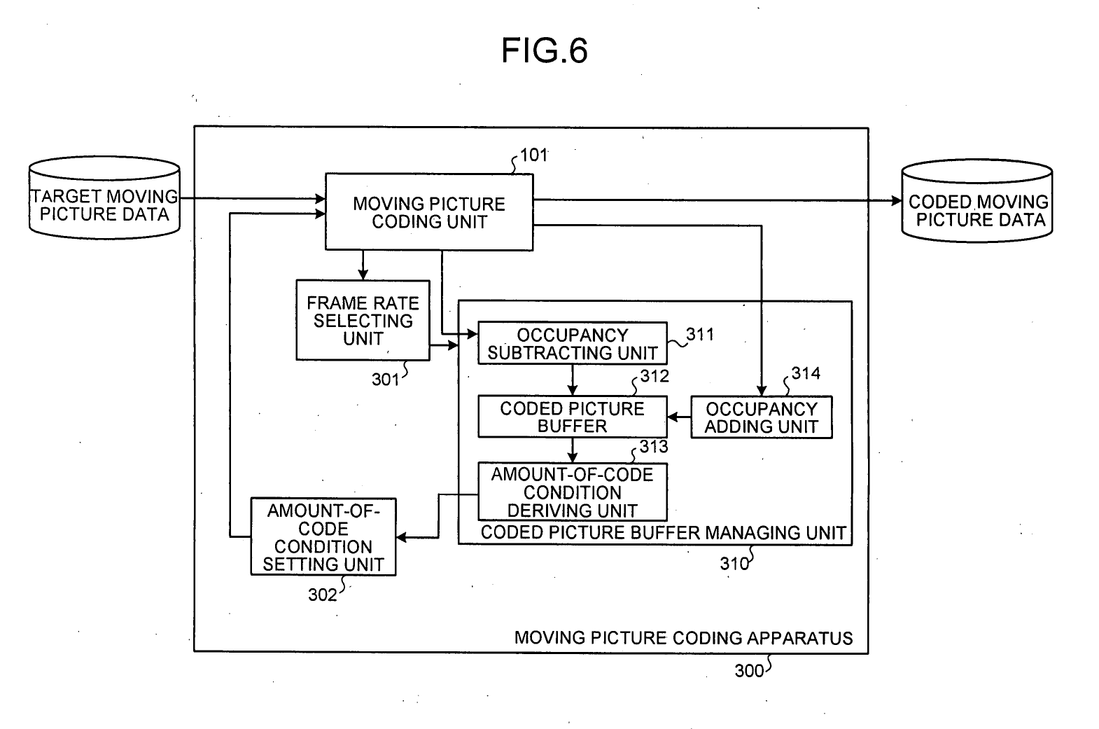

FIG. 6 is a block diagram of a structure of the moving picture coding apparatus according to the second embodiment. The moving picture coding apparatus 300 includes a moving picture coding unit 101, a frame rate selecting unit 301, a amount-of-code condition setting unit 302, and a coded picture buffer managing unit 310. The coded picture buffer managing unit 310 includes an occupancy subtracting unit 311, a coded picture buffer 312, a amount-of-code condition deriving unit 313, and an occupancy adding unit 314. The moving picture coding apparatus 300 with the above-described structure can generate coded moving picture data which satisfies a condition as not to cause underflow even when the coded moving picture data is generated from received target moving picture data and rendered at various frame rates. When the rate control is performed with VBR, the overflow does not need to be considered. The process performed by the moving picture coding unit 101 is same with the process in the first embodiment and the description thereof is not repeated.

In the second embodiment, the coded moving picture data supplied from the moving picture coding apparatus 300 is rendered at a frame rate for rendering in PAL and a frame rate for rendering in NTSC as examples of employable plural frame rates for rendering of the coded moving picture data. Further, the peak rates of the frame rate for rendering in PAL and the frame rate for rendering in NTSC are assumed to be same. It should be noted that the embodiment does not intend to limit the target frame rate to the two frame rates mentioned above.

Further, the coded moving picture data supplied from the moving picture coding apparatus 300 includes timing data for rendering in PAL similarly to the data in the first embodiment. Here, the embodiment does not intend to limit the supplied coded moving picture data to the data including the timing data for rendering in PAL and data with timing data for any employable frame rate for rendering can be supplied.

Here, the modification of the timing data for rendering in NTSC is performed by the moving picture multiplexing editing apparatus 1100 similarly to the first embodiment. The process of timing data modification is also same with the first embodiment and the description thereof is not repeated.

The frame rate selecting unit 301 selects a highest frame rate from plural frame rates. In the second embodiment, a frame rate for rendering in PAL, which is the highest frame rate, is selected from the frame rate for rendering in PAL and a variation-averaged frame rate for rendering in NTSC. Here, the embodiment does not intend to limit the highest frame rate to the frame rate for rendering in PAL.

The coded picture buffer managing unit 310 performs process up to the derivation of the amount-of-code condition for rendering at the highest frame rate selected by the frame rate selecting unit 301. Hereinbelow, the elements of the coded picture buffer managing unit 310, i.e., the coded picture buffer 312, the occupancy adding unit 314, the occupancy subtracting unit 311, and the amount-of-code condition deriving unit 313 are described.

The coded picture buffer 312 virtually realizes a receive buffer utilized at rendering of the data at the highest frame rate selected by the frame rate selecting unit 301, and stores the capacity of the receive buffer and the buffer occupancy of the receive buffer at rendering of the coded moving picture data supplied from the moving picture coding unit 101.

The occupancy adding unit 314 adds an increase in the buffer occupancy from the removal time of picture k−1 to the removal time of picture k according to a bit rate of the highest frame rate selected by the frame rate selecting unit 301 to the coded picture buffer 312.

The occupancy subtracting unit 311 subtracts the amount-of-code of picture k by the coding of the target moving picture data by the moving picture coding unit 101 from the buffer occupancy stored in the coded picture buffer 312 at the removal time of picture k at the highest frame rate selected by the frame rate selecting unit 301. Here, k is an integer equal to or larger than zero and corresponds to the number of pictures contained in the received target moving picture data.

In the second embodiment, when the employable plural frame rates for rendering include a variable frame rate such as a frame rate for rendering in NTSC, such frame rate is treated as a frame rate where variation is averaged (also referred to as a variation-averaged frame rate). For the processing at the variation-averaged frame rate, an average of the removal time is employed as the removal time, and the subtraction of the amount-of-code of picture k is performed at an averaged removal time.

The amount-of-code condition deriving unit 313 derives a condition on the amount-of-code of picture k supplied from the moving picture coding unit 101 so as to prevent the underflow caused by the subtraction of the buffer occupancy of the coded picture buffer 312 by the occupancy subtracting unit 311.

The amount-of-code condition setting unit 302 derives a condition on the amount-of-code of picture k coded by the moving picture coding unit 101 so as to satisfy the condition derived by the amount-of-code condition deriving unit 313 on an amount of data transfer for the coded moving picture data, and sets the coding condition such as quantization value information and information on coding mode selection that affects the amount-of-code, to control the amount-of-code so as to satisfy the condition. With such process, the condition can be set so as to prevent the underflow in PAL and NTSC.

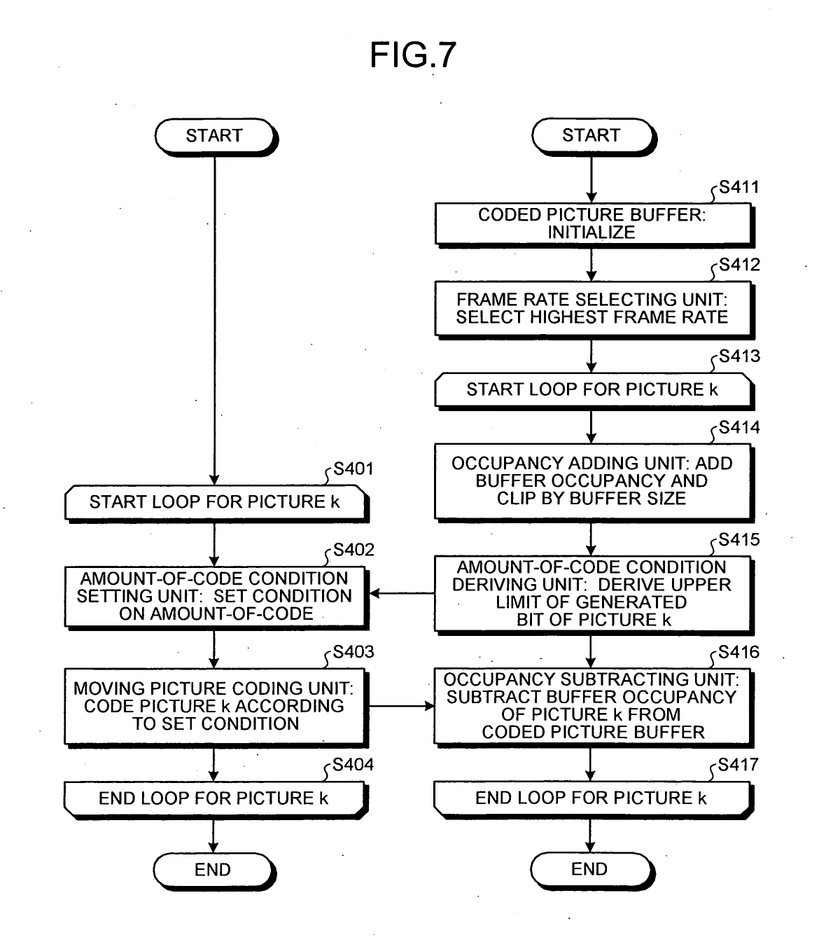

Next, a process in the moving picture coding apparatus 300 according to the second embodiment is described where the coded moving picture data which does not cause underflow at rendering in PAL and NTSC is generated from the target moving picture data. FIG. 7 is a flowchart of an overall process in the moving picture coding apparatus 300 according to the second embodiment where the coded moving picture data is generated from the target moving picture data. Here, the peak rates corresponding to respective frame rates in PAL and NTSC are assumed to be same and the peak rate is represented as peak_bit_rate.

First, initialization of the coded picture buffer 312 is performed (step S411). Specifically, an initial buffer occupancy (the constant is referred to as initial_cpb_occupancy hereinbelow) is supplied as an input for a buffer occupancy (the variant is referred to as first_cpb_occupancy(k) hereinbelow) by the coded moving picture data in the coded picture buffer 312 as represented by Expression (21):
first_cpb_occupancy(−1)=initial_cpb_occupancy (21)

The frame rate selecting unit selects the highest frame rate (step S412). In the second embodiment, the highest frame rate is selected from the frame rate for rendering in NTSC and the frame rate for rendering in PAL, hence, the frame rate for rendering in PAL is selected.

Then the process from step S414 to step S416 is performed as a loop until the coding is finished for all pictures contained in the target moving picture data starting from k=0 of picture k (step S413).

The occupancy adding unit 314 performs clipping using a sum of an increase in the buffer occupancy from the removal time of picture k−1 to the removal time of picture k according to the bit rate of the highest frame rate and an occupancy of the coded picture buffer 312 (step S414). Specifically the process is performed as represented by Expression (22):
first_cpb_occupancy(k)=clip(0, size of coded picture buffer, first_cpb_occupancy(k−1)+peak_bit_ratex{(removal time of picture k at frame rate)−(removal time of picture k−1 at frame rate}) (22)

Here, “clipping” indicates an expression where Clip(min, max, value) indicates min when value<min, max when value>max, and value only when min=value=max.

Here, in picture 0 (picture k where k=0), the removal time of picture k−1 at the highest frame rate and the removal time of picture k at the highest frame rate are same and calculated according to Expression (22).

The amount-of-code condition deriving unit 313 derives an upper limit of the amount-of-code of picture (selected_max_bits) to prevent the underflow immediately after the removal of the picture k in the coded picture buffer at the highest frame rate, and supplies the result as an output to the amount-of-code condition setting unit 302 (step S415). Here, the value of selected_max_bits is determined so that even when the amount-of-code of picture k is selected_max_bits, at least 1 bit remains as the buffer occupancy of the coded picture buffer 312 immediately after the removal of picture k. In other words, the relation (first_cpb_occupancy−1)=selected_max_bits must holds. In the second embodiment, since the rate control is realized with VBR, the overflow does not occur even if the amount-of-code is small. Hence the derivation of the lower limit of the bit amount of picture k is not necessary.

When the frame rate is variable as the frame rate for rendering in NTSC, the process is performed based on the average removal time. Then, since the average removal time is different from an actual removal time, the occupancy stored in the coded picture buffer 312 differs from the buffer occupancy at an actual rendering. However, in the second embodiment the difference does not need to be considered. The reason is described later.

Next, the reason is described why the buffer occupancy of the coded picture buffer 312 is set so that the buffer occupancy is at least 1 bit immediately after the removal of picture k. In the interval between the removal time of picture k−1 and picture k, increased amount of buffer occupancy, which is a product of the time interval and peak_bit_rate, may be a decimal number. However, the actual buffer occupancy is an integer. Then, there is less than one bit difference between a value obtained via calculation and an actual value. Therefore, a margin is provided to maintain the buffer occupancy of the coded picture buffer 312 immediately after the removal of the picture k at a level at least one bit, and thus selected_max_bits is determined. Hence, the underflow does not occur in rendering at other frame rates.

The occupancy subtracting unit 311 subtracts the amount-of-code of picture k supplied from the moving picture coding unit 101 in step S403 described alter from the buffer occupancy of the coded picture buffer 312 (step S416). Specifically the process is performed as represented by Expression (23):
selected_cpb_occupancy(k)=selected_cpb_occupancy(k)−amount-of-code of picture k (23)

After the completion of the subtraction of the amount-of-code in step S416, the process returns to step S414 and repeat the process (up to step S417). Thereafter, with the completion of coding for all pictures in the target moving picture data, the process finishes.

Then, the processes performed by the amount-of-code condition setting unit 302 and the moving picture coding unit 101 are also repeated as a loop for picture k (starting from k=0) until the coding finishes for all pictures in the target moving picture data (step S401).

Then the amount-of-code condition setting unit 302 sets the coding condition as to satisfy the condition on the upper limit of the amount-of-code of picture k according to selected_max_bits supplied in step S415 (step S402).

Further, the amount-of-code condition setting unit 302 supplies the coding condition such as the quantization value information to the moving picture coding unit 101 as to satisfy Expression (24):
amount-of-code of picture k≦selected_max_bits (24)

The moving picture coding unit 101 codes picture k as to satisfy the supplied coding condition (step S403). Further, the moving picture coding unit 101 supplies the amount-of-code of picture k as an output to the occupancy subtracting unit 311.

After the completion of the coding of picture k up to step S404, the process returns to step S401 where the loop starts (step S404). The process finishes when the coding of all pictures in the target moving picture data finishes.

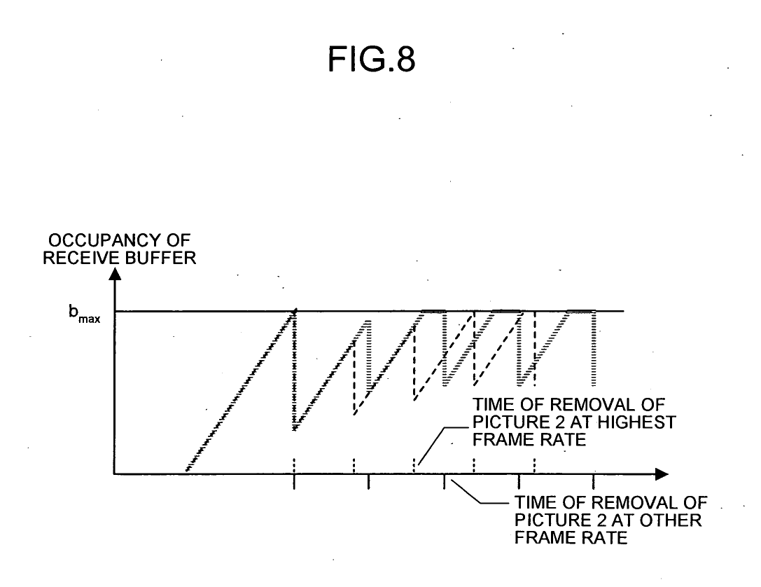

FIG. 8 is a graph of a transition of buffer occupancy of the receive buffer at various frame rates at rendering of the coded moving picture data supplied according to the process described above. A chain line represents the transition at the highest frame rate and a mesh line represents the transition for other frame rate. The size of the available area of receive buffer is represented as bₘₐₓ.

In the embodiment, the peak rates of plural frame rates are assumed to be the same. The buffer occupancy of the receive buffer at the highest frame rate is always equal to or lower than the buffer occupancy of the receive buffer at other frame rate whether it is immediately after or before the removal of picture k as shown in FIG. 8, and never become higher.

Since the receive buffer of the highest frame rate performs control as to prevent underflow through the process as shown in FIG. 4, the underflow can be prevented computationally in rendering at other frame rate as well.

Hence, the moving picture coding apparatus 300 can supply the coded moving picture data which is renderable at various frame rates according to the process as described above. Further, since the coding can be realized in consideration only of one frame rate, the process load can be lightened.

Here, though “(removal time of picture k)−(removal time of picture k−1)” is constant at the frame rate for rendering in PAL, the value is not constant due to the 3:2 pulldown at the frame rate for rendering in NTSC.

Because of the difference in the time period, when the average removal time is employed, the difference is generated between the buffer occupancy of the coded picture buffer and the buffer occupancy of the receive buffer at the actual rendering of coded moving picture data. The difference is always generated regardless of the employed frame rate, i.e., whether it is the highest frame rate or not.

For example, assume that the target moving picture data in 24000/1001 fps (frame/sec) is subjected to 3:2 pulldown to generate image data renderable in NTSC at 30000/1001 fps, i.e., 60000/1001 field/sec. The bit rate here is represented as ntsc_bit_rate. The variation-averaged frame rate without 3:2 pulldown is 24000/1001 fps.

When 3:2 pulldown is performed, the interval of picture removal from the receive buffer at rendering varies depending on the picture number. In the second embodiment, the interval in NTSC regularly changes according to the number of generated fields, i.e., 3, 2, 3, 2. In other words, the removal at the variation-averaged frame rate is conducted every 2.5 fields. Then the shift in the removal time happens only for the odd-numbered picture, where the removal time delays by 0.5 field. In the second embodiment, the removal time is assumed to delay (take a positive value) also at other variable frame rate.

More specifically, assume that the removal time of picture 0 which is the 0th picture at the variable frame rate and the variation-averaged frame rate is represented by zero. Then, the removal time of picture 1 at the variation-averaged frame rate is 1001/24000 sec. The removal time of picture 1 at the variable frame rate is ( 1001/60000)×3 sec. The difference in the removal time is represented by Expression (25):
( 1001/60000)'3− 1001/24000= 1001/120000 (25)

Thus, between the variation-averaged frame rate and the actual variable frame rate, the difference in the removal time of picture 1 is 1001/120000 seconds.

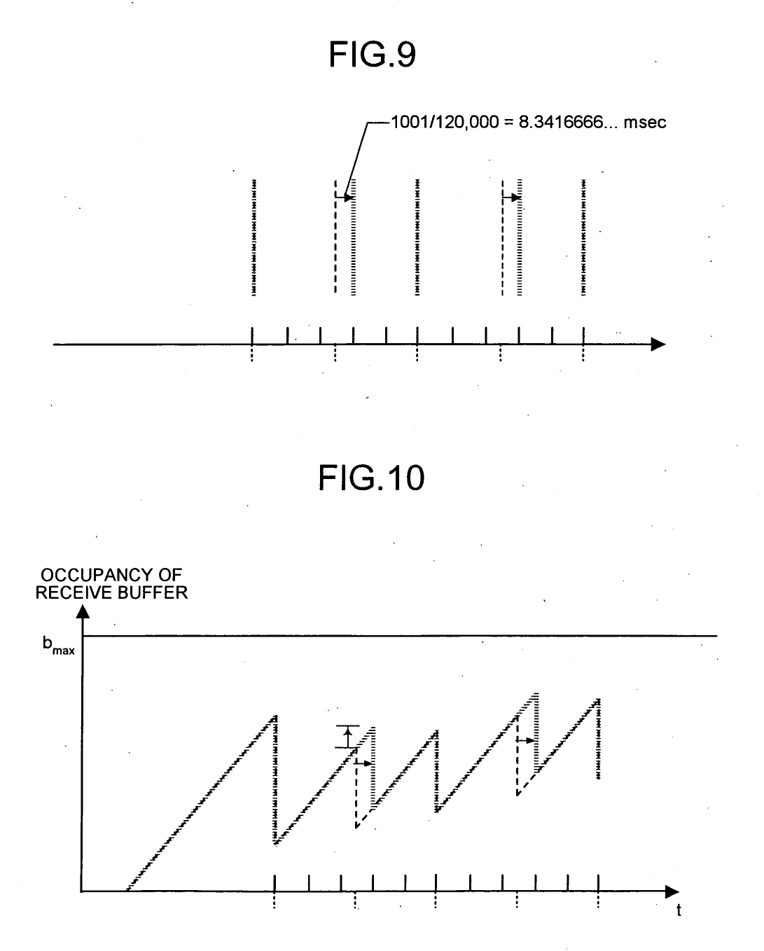

FIG. 9 is a graph of the difference in the removal time between the variation-averaged frame rate and the frame rate for rendering in NTSC. In FIG. 9, the mesh line represents the removal time of each picture from the receive buffer at the variable frame rate, whereas the chain line represents the removal time of each picture from the receive buffer at the variation-averaged frame rate. With reference to FIG. 9, the removal time at these two frame rates cyclically match and shift by 1000/12000 sec as represented by the expression (25) every one picture.

When 3:2 pulldown is performed for rendering in NTSC, one cycle corresponds with two pictures, and hence the maximum shift is 1001/120000 seconds. The matching cycle of the variable frame rate and the variation-averaged frame rate varies according to the employed variable frame rate, and the maximum difference in the buffer occupancy must be calculated as a maximum in the cycle.

FIG. 10 is a graph of difference in transition of the buffer occupancy caused by the difference in the removal time in the variation-averaged frame rate and in the frame rate for rendering in NTSC. In FIG. 10, the mesh line represents the transition of the buffer occupancy at the variable frame rate, whereas the chain line represents the buffer occupancy at the variation-averaged frame rate. As can be seen from FIG. 10, when the removal time of picture is different in the variable frame rate and in the variation-averaged frame rate, the buffer occupancy of the receive buffer differs for each frame rate accordingly.

The difference in the transition of the buffer occupancy is calculated according to Expression (26):
ntsc_bit_ratex{(removal_time of picture 2k′ at variable frame rate)−(removal time of picture 2k′−1 at variation avaraged frame rate)} (26)

The difference represented by Expression (26) can take either a positive value or a negative value. When the number of fields generated in 3:2 pulldown shows the pattern of 3, 2, 3, 2, the difference is positive as in FIG. 8 whereas the number of fields shows the pattern of 2, 3, 2, 3, the difference is negative. In the embodiment the difference is treated as a positive value.

Since the rate control in the moving picture coding apparatus 300 according to the second embodiment is conducted with the variable rate, no consideration on overflow is necessary. Hence, when the average removal time shifts in a positive direction, the transition in the variable frame rate matches with or exceeds the transition in the variation-averaged frame rate, and never become lower as shown in FIG. 10. In other words, when the difference is always positive as in the second embodiment, the difference in the buffer occupancy in the variable frame rate and the variation-averaged frame rate does not cause underflow, and hence the difference does not require consideration. Thus, the moving picture coding apparatus 300 according to the second embodiment does not require particular processing to deal with such difference.

It should be noted that the second embodiment does not intend to limit the employable plural frame rates to the frame rates for PAL and NTSC. In addition, the second embodiment does not limit the plural frame rates employed in the moving picture coding apparatus 300 to the frame rates with the same peak rate. A highest frame rate may have a peak rate higher than a peak rate of other employed frame rate. When the peak rate of the highest frame rate is lower than the peak rate of other frame rate, the coding condition is set to accommodate the shift caused by the difference in the peak rates.

The moving picture coding apparatus 300 according to the second embodiment controls the generated bit amount of picture k so as to prevent underflow at the receive buffer at the highest frame rate among plural employable frame rates for rendering. Hence, the coded moving picture can be rendered at various frame rates. Thus, compared with an apparatus which codes the image for each frame rate, the apparatus of the embodiment can reduce the time required for coding and save the disc space for coding.

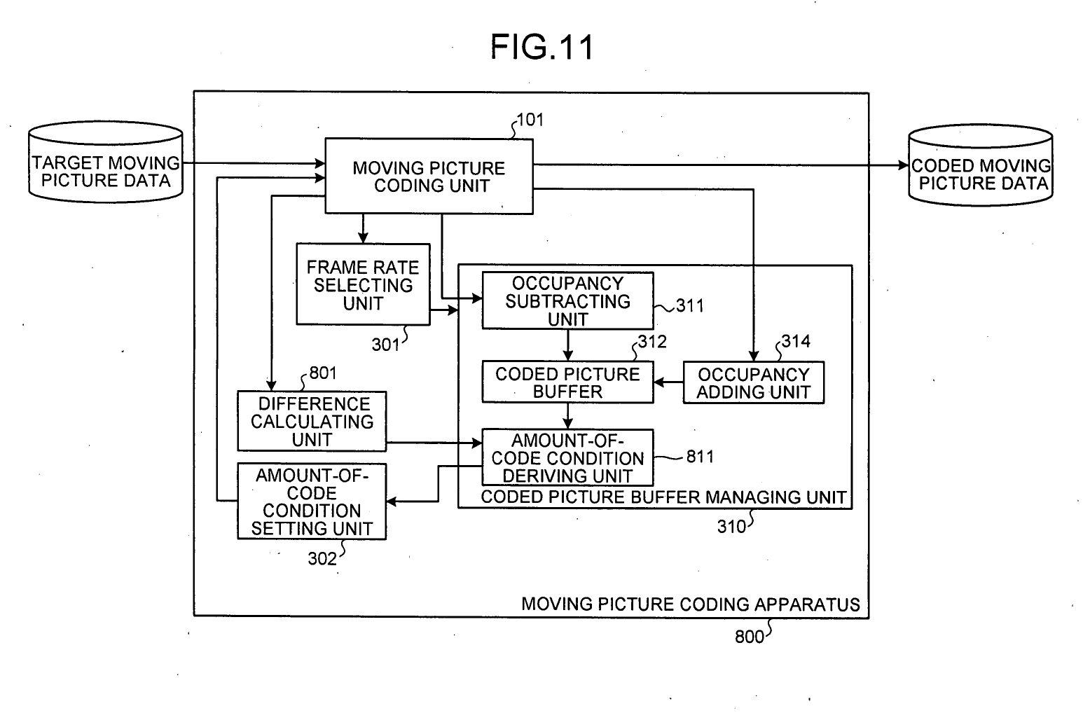

FIG. 11 is a block diagram of a structure of the moving picture coding apparatus according to a third embodiment. A moving picture coding apparatus 800 according to the third embodiment is suitable for the rate control with VBR at data conversion. The moving picture coding apparatus 800 has a structure where a difference calculating unit 801 is added to the structure of the moving picture coding apparatus 300 of the second embodiment. The moving picture coding apparatus 800 with such a structure can generate coded moving picture data which satisfies a condition as to prevent the underflow even when the average removal time shifts in a negative direction compared with the removal time at the variable frame rate among the plural employable frame rates for rendering. When the rate control is performed with VBR, the consideration on overflow is not necessary. In the following, the same components as in the second embodiment are denoted with same reference characters and the description thereof is not repeated.

In addition, since a moving picture multiplexing editing apparatus which multiplexes the moving picture data coded by the moving picture coding apparatus 800 employs the same components as the moving picture multiplexing editing apparatus 1100 of the first embodiment, the description thereof is not repeated.

The difference calculating unit 801 calculates a maximum value of the difference in the buffer occupancy of the receive buffer at the average removal time and the buffer occupancy in an actual processing caused by the difference in the actual removal time and the average removal time, and outputs the calculated maximum value to the amount-of-code condition deriving unit 811.

When there are many variable frame rates among the employable frame rates for rendering of the coded moving picture data, the difference calculating unit 801 calculates the maximum difference in buffer occupancy caused by the employable variable frame rates.

In the third embodiment, the frame rates for rendering in PAL and NTSC are used as the employable plural frame rates, though the embodiment does not intend to limit the employable frame rates to these two. Further, though the description on the calculation of the difference is provided based on 3:2 pulldown in the third embodiment, the calculation may be based on other conversion techniques. The calculation of the difference is described later.

When 3:2 pulldown is conducted on the image data, the time interval of the picture removal from the receive buffer varies according to the picture number. In the third embodiment, the time interval is regularly repeated as 2 fields, 3 fields, 2 fields, 3 fields, etc. In the moving picture coding apparatus 800, the difference between the time of actual removal and the average removal time at the variable frame rate may take either a positive value or a negative value.

The amount-of-code condition deriving unit 811 derives a condition of generated bit of picture k output from the moving picture coding unit 101 based on the calculated maximum value of the difference provided by the difference calculating unit 801. Specifically, the amount-of-code condition deriving unit 811 derives an upper limit of the generated bit of picture k (selected_max_bits) so that the buffer occupancy in the available area of the receive buffer stored by the coded picture buffer 312 does not become lower than the maximum value of difference supplied by the difference calculating unit.

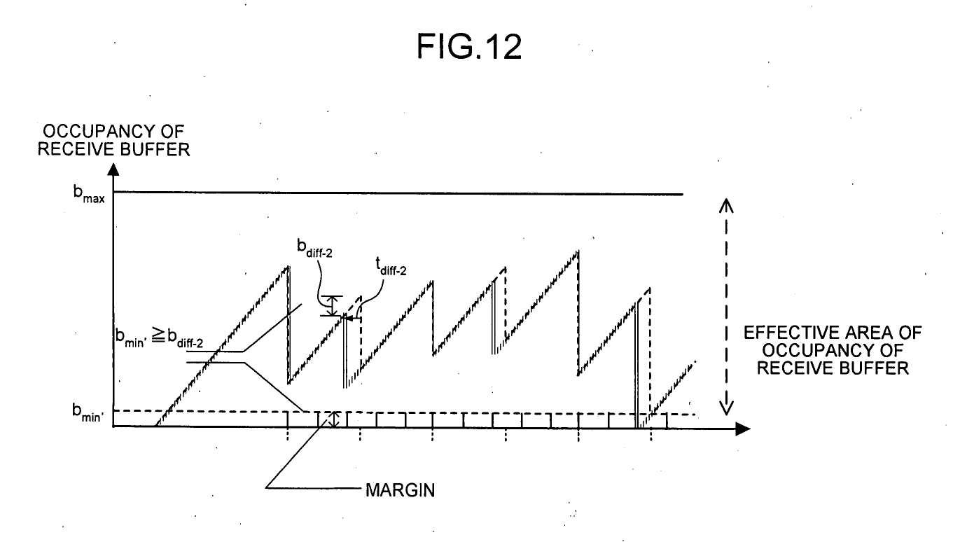

FIG. 12 is a graph of the difference in transition of buffer occupancy produced by the difference in the time of picture removal when the removal time at the variation-averaged frame rate shifts in a negative direction from the removal time at the frame rate for rendering in NTSC.

Here, a difference between the removal time at the variation-averaged frame rate and the frame rate for rendering in NTSC is represented as t_{diff}_{_{—}}₂. When the ratio of increase in the buffer occupancy over time is constant and the time difference t_{diff}_{_{—}}₂ is determined, the difference in the buffer occupancy b_{diff}_{_{—}}₂ is also determined. Then, if a predetermined margin bₘᵢₙ, is taken from the lower limit 0 of the receive buffer, and the relation b_{min′≧}b_{diff}_{_{—}}₂ holds, the underflow does not occur.

Thus, the amount-of-code condition deriving unit 811 sets the lower limit as the value of the sum of the maximum value of difference calculated by the difference calculating unit 801 and the actual lower limit of the receive buffer (zero in the third embodiment), in order to derive the condition to prevent the underflow. As far as the amount-of-code deriving unit 811 derives the coding condition that does not lower the set lower limit, the underflow does not occur even if the difference is maximum at the removal time of picture k. Specifically, the amount-of-code condition deriving unit 313 determines first_max_bit so that the buffer occupancy immediately after the removal of picture k in the coded picture buffer 312 is at least max (i.e., the maximum difference, 1 bit).

The moving picture coding apparatus 800 with the above-described structure can code the image so as to prevent the underflow for plural frame rates including a variable frame rate regardless of the sign of the difference caused by the variation in frame rate.

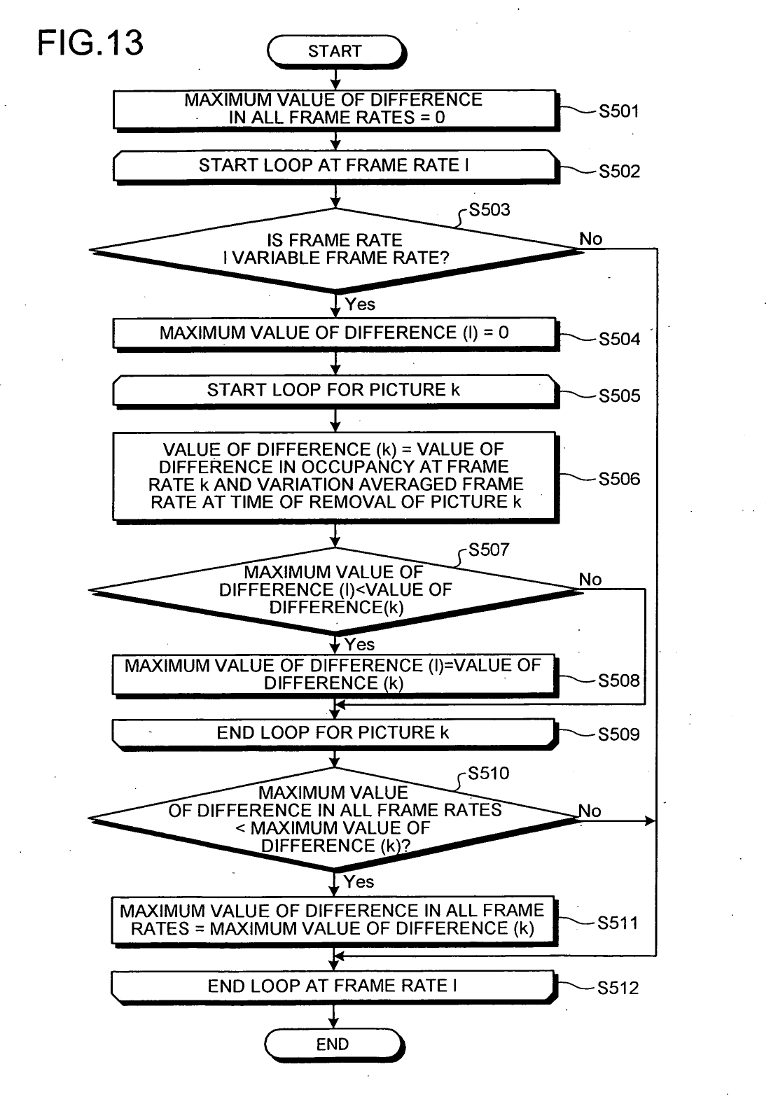

Next, a description is given on processing of the coded moving picture data coded by the moving picture coding apparatus 800 with the above-described structure according to the third embodiment, up to the calculation of the maximum value of the difference in all employable frame rates for rendering by the difference calculating unit 801. FIG. 13 is a flowchart of a process in the moving picture coding apparatus 800 according to the third embodiment up to the calculation of the maximum value of the difference in all employable frame rates.

First, the difference calculating unit 801 initializes the maximum value of difference for all frame rates (b_{dif}_{_{—}}ₘₐₓ) to zero (step S501).

Then, the difference calculating unit 801 starts the loop to conduct the process from step S503 to step S511 for all employable frame rates (step S502). In the third embodiment, the process from step S503 to step S511 is performed for the frame rates for rendering in NTSC and PAL.

First, the difference calculating unit 801 determines whether a frame rate 1 is a variable frame rate or not (step S503). On determining that the frame rate 1 is a variable frame rate (Yes in step S503), the difference calculating unit 801 initializes the maximum value of difference (b_{dif}_{_{—}}₍₁₎_{_{—}}ₘₐₓ) of the frame rate 1 to zero (step S504). Here, the description is given on the case where the difference calculating unit 801 determines that the frame rate 1 is a variable frame rate for rendering in NTSC.

Then, the difference calculating unit 801 performs the process as a loop for every picture for the frame rate 1 (step S505) to check the difference in the buffer occupancy of the receive buffer based on the variation in removal time. The process from step S506 to step S508 may be repeated for pictures of one cycle, which is a time period from the time when the removal time at a variable frame rate 1 and the removal time at a variation-averaged frame rate starts to differ until they comes to match with each other again. For a picture for which such difference clearly does not occur, the process from step S506 to step S508 can be omitted.

The difference calculating unit 801 calculates the difference (b_{dif}_{_{—}}₍₁₎_{_{—}}₍ₖ₎) between the buffer occupancy of the receive buffer at the variable frame rate at the removal time of picture k and the buffer occupancy of the receive buffer at the variation-averaged frame rate which is an average of the variation of frame rate k (step S506). Specifically, the value calculated according to Expression (12) described earlier is the value of difference for the frame rate for rendering in NTSC.

The difference calculating unit 801 determines whether the calculated value of difference in step S506 (b_{dif}_{_{—}}₍₁₎_{_{—}}₍ₖ₎) is larger than the maximum value of difference (b_{dif}_{_{—}}₍₁₎_{_{—}}ₘₐₓ) or not (step S507).

On determining that the value of difference (b_{dif}_{_{—}}₍₁₎_{_{—}}₍ₖ₎) is larger than the maximum value of difference (b_{dif}_{_{—}}₍₁₎_{_{—}}ₘₐₓ) (Yes in step S507), the difference calculating unit 801 updates the maximum value of difference (b_{dif}_{_{—}}₍₁₎_{_{—}}ₘₐₓ) with the value of difference (b_{dif}_{_{—}}₍₁₎_{_{—}}₍ₖ₎) (step S508). On determining that the value of difference (b_{dif}_{_{—}}₍₁₎_{_{—}}₍ₖ₎) is smaller than the maximum value of difference (b_{dif}_{_{—}}₍₁₎_{_{—}}ₘₐₓ) (No in step S507) the difference calculating unit 801 does not perform any particular process.

Thus the process finishes for picture k (step S509). When the process from step S506 to step S508 has not finished for pictures of one cycle, the difference calculating unit 801 starts the process for next picture k+1 (step S505).

Then, the difference calculating unit 801 determines whether the maximum value of difference (b_{dif}_{_{—}}₍₁₎_{_{—}}ₘₐₓ) found by the process for the frame rate k is larger than the maximum value of difference for all frame rates (b_{dif}_{_{—}}ₘₐₓ) or not (step S510). On determining that the maximum value of difference (b_{dif}_{_{—}}₍₁₎_{_{—}}ₘₐₓ) is larger than the maximum value of difference for all frame rates (b_{dif}_{_{—}}ₘₐₓ) (Yes in step S510), the difference calculating unit 801 updates the maximum value of difference for all frame rates (b_{dif}_{_{—}}ₘₐₓ) with the maximum value of difference (b_{dif}_{_{—}}₍₁₎_{_{—}}ₘₐₓ) (step S511). On determining that the maximum value of difference (b_{dif}_{_{—}}₍₁₎_{_{—}}ₘₐₓ) is smaller than the maximum value of difference for all frame rates (b_{dif}_{—}ₘₐₓ) (No in step S510), the difference calculating unit 801 does not perform a particular process.

On determining that the frame rate 1 is not variable (No in S503), or that the maximum value of difference (b_{dif}_{_{—}}₍₁₎_{_{—}}ₘₐₓ) is smaller than the maximum value of difference of all frame rates (b_{dif}_{_{—}}ₘₐₓ) (No in step S501), or the process sequence finishes up to S511, the difference calculating unit 801 ends the process for the frame rate 1 (step S512) and starts the process for a frame rate 1+1 (step S502). When the process for all frame rates finishes, the process ends without returning to the beginning of the loop.

With the process as described above, the maximum value of difference for all frame rates can be acquired. Then, the amount-of-code condition deriving unit 811 derives the condition for amount-of-code considering the maximum value of difference supplied by the difference calculating unit 801.

Thus, the amount-of-code condition deriving unit 811 derives the amount-of-code condition in consideration of the maximum value of difference calculated by the difference calculating unit 801, and the amount-of-code condition setting unit 302 sets the coding condition such as the quantization value information and the coding mode selection information which affects the amount-of-code to control the generated bit amount to satisfy the amount-of-code condition, and the moving picture coding unit 101 codes the target moving picture data supplied as an input. Hence, the coded moving picture data can be generated so as to prevent the underflow regardless of the sign of the difference caused by the variable frame rate.

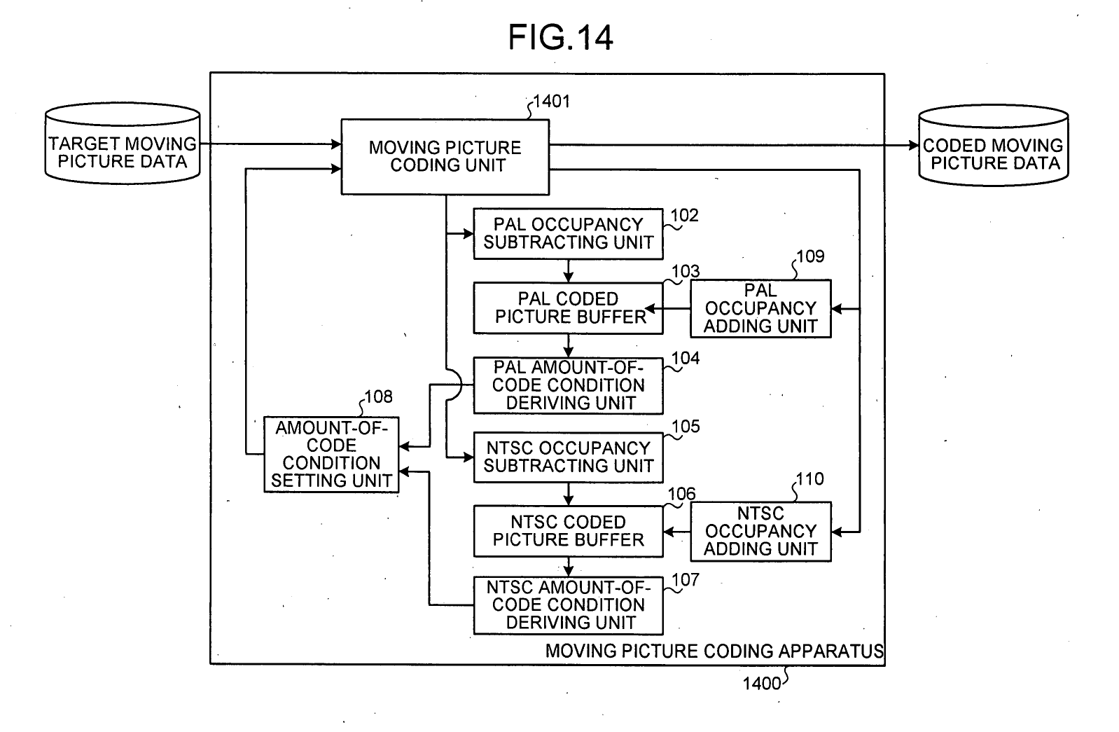

FIG. 14 is a block diagram of a structure of a moving picture coding apparatus 1400 according to a fourth embodiment. The moving picture coding apparatus 1400 is suitable for the rate control by CBR at data conversion. The moving picture coding apparatus 1400 includes a moving picture coding unit 1401 which performs a different process from the moving picture coding apparatus 100 according to the first embodiment. The moving picture coding apparatus with such a structure can generate coded moving picture data with timing data which allows rendering of the coded image data at plural frame rates.

The coding by the moving picture coding unit 1401 according to the fourth embodiment is feasible not only in the apparatus of the fourth embodiment, and can be realized in the apparatus of the second or the third embodiment with the moving picture coding unit 101 replaced with the moving picture coding unit 1401.

In the fourth embodiment, the timing data for plural frame rates is included in the coded moving picture data. Hence, the modification of the timing data by the moving picture multiplexing editing apparatus 1100 is not necessary. The coded moving picture data is multiplexed with the overlay picture containing the timing data for plural frame rates and the audio data for plural frame rates. The multiplexing according to the fourth embodiment is performed in a conventionally well known method, though the present invention is not limited thereto.

The moving picture coding unit 1401 codes the target moving picture data supplied according to the coding condition set by the amount-of-code condition setting unit 108, adds the timing data for plural frame rates, and outputs the resulting coded moving picture data. In the fourth embodiment, the moving picture data is coded according to H.264. The coding format is not limited to H.264, and other formats such as MPEG2 can be employed.

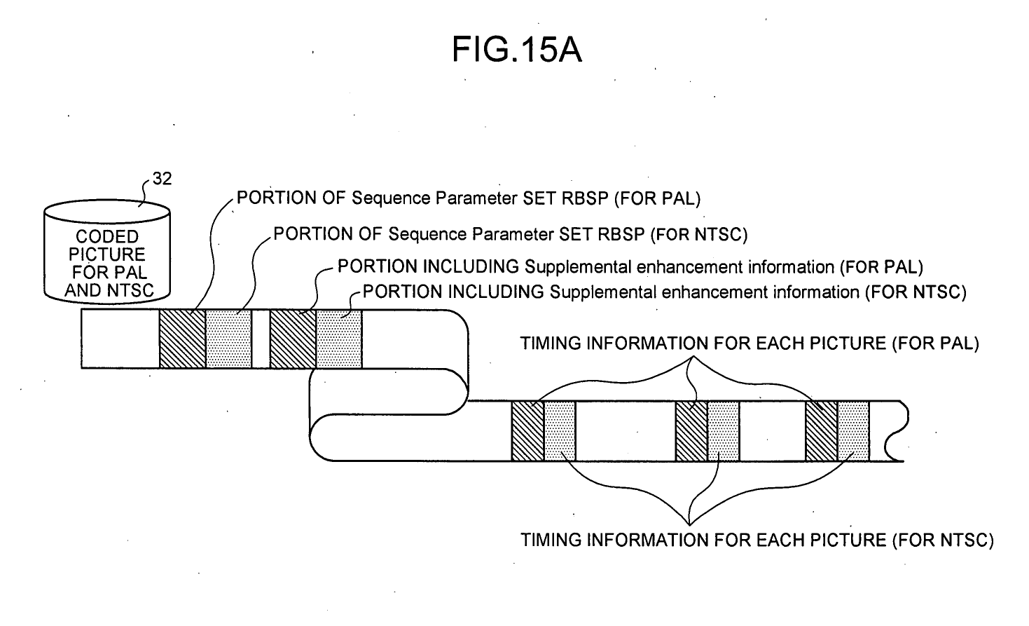

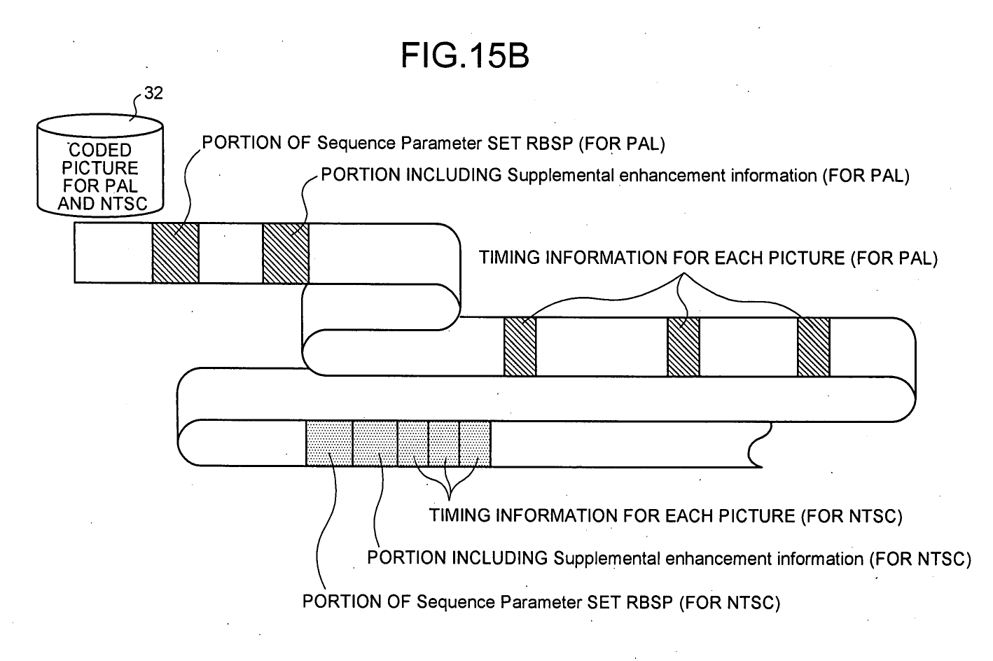

FIG. 15A is a diagram of an example of coded moving picture data supplied as an output from the moving picture coding unit 1401. As shown in FIG. 15A, the timing data corresponding to plural frame rates is inserted. Hence, the coded moving picture data can be rendered at any frame rates corresponding to the inserted timing data. Plural pieces of timing data may be inserted in a different manner.

FIG. 15B is a diagram of an example of coded moving picture data supplied as an output from a moving picture coding unit of another embodiment. As shown in FIG. 15B, the timing data for one frame rate is inserted to the same portion as shown in FIG. 14, while the timing data for other frame rate is inserted into the end of the timing data. With such structure, rendering of data can be realized in the conventional manner for one frame rate, whereas for another frame rate rendering can be performed with reference to the timing data inserted to the end of the timing data.

The moving picture coding apparatus 1400 according to the fourth embodiment can render the coded moving picture data at plural frame rates without causing underflow nor overflow at plural frame rates, since the timing data corresponding to plural frame rates is added thereto.

Further the present invention is not limited to the embodiments as described above and various modification as illustrated below can be realized.

For example, in the above-described embodiments, the coding condition set by the amount-of-code condition setting unit (108, 302), or the generated bit by the coding of the moving picture coding unit (101, 1401) are processed for each picture. However, one picture can be divided into a smaller image unit such as a slice, a macroblock, or a block. Then, the following processes are performed after every completion of the coding of the image unit. Specifically, the generated bit by the coding may be subtracted from the (PAL, NTSC) coded picture buffer (103, 106, 312) by the occupancy subtracting unit (105, 311), and the (PAL, NTSC) amount-of-code condition deriving unit (104, 107, 313) may derive the upper limit and the lower limit of the generated bit for each image unit, and the amount-of-code condition setting unit (108, 302) may output the coding condition such as the quantization value information for each image unit and the coding mode selection information that affects the amount-of-code to the moving picture coding unit (101, 1401).

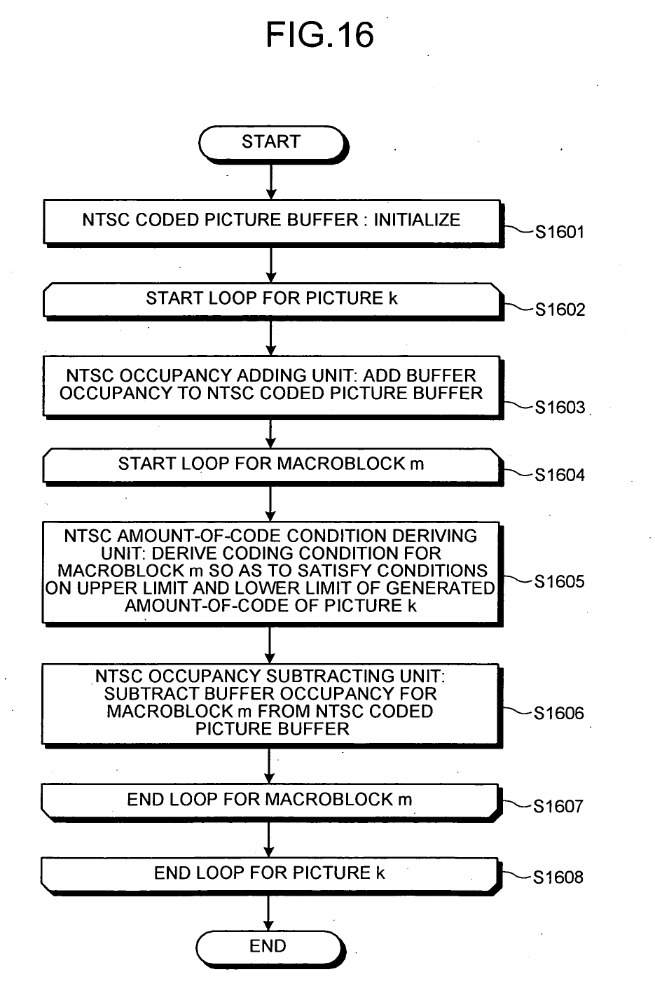

FIG. 16 is a flowchart of a coding process performed for each macroblock. For the simplicity of description, the process which replaces the process from step S221 to step S226 shown in FIG. 3 for the coded picture buffer (106) for NTSC according to the first embodiment is described. Here, the image unit is not limited to a macroblock and a slice or a block can be employed.

First, similarly to steps S221-S223 of FIG. 3 of the first embodiment, the process is performed starting with the initialization of the NTSC coded picture buffer 106 up to the addition by the NTSC occupancy adding unit 110 (steps S1601-S1604).

Then, the process of step S1604 to S1606 is performed repeatedly for macroblock m of picture k. The NTSC amount-of-code condition deriving unit 107 derives the coding condition (condition at the coding which affects the generated bit amount such as the quantization value or the selected coding mode) for coding the macroblock m to satisfy the condition of upper limit and lower limit of the generated amount-of-code of picture k and supplies the derived coding condition to the amount-of-code condition setting unit 108 (step S1605).

Then, according to a process which is different from the process in steps S212 and S231 in FIG. 3 in that the picture k is replaced with the macroblock m, but in other respects same with the process in steps S212 and S231, the generated bit by the coding of macroblock m by the moving picture coding unit 101 is supplied to the NTSC occupancy subtracting unit 105 (not shown). Then the NTSC occupancy subtracting unit 105 subtracts the supplied generate bit from the NTSC coded picture buffer 106 (step S1606). Thus, the process for the macroblock m completes (step S1607), and the process for a next macroblock m+1 starts (step S1604).

As described in the above modification, the moving picture coding apparatus can adopt a unit other than the picture as the image unit for moving picture data coding.

Further, though in the first embodiment, the correspondence between the frame rate and the bit rate is not particularly specified, the ratio of plural frame rates may be set equal to the ratio of bit rates of the plural frame rates.

For example, the bit rates for rendering in PAL and NTSC may be set corresponding to the frame rates for rendering in PAL and NTSC. Specifically, the ratio of the bit rate for rendering in PAL (pal_bit_rate) to the bit rate for rendering in NTSC (ntsc_bit_rate) is set equal to the ratio of the frame rate for rendering in PAL to the frame rate for rendering in NTSC. In other words, the bit rate for rendering in NTSC is set as “(the bit rate for rendering in PAL)×(frame rate for rendering in NTSC/frame rate for rendering in PAL).”

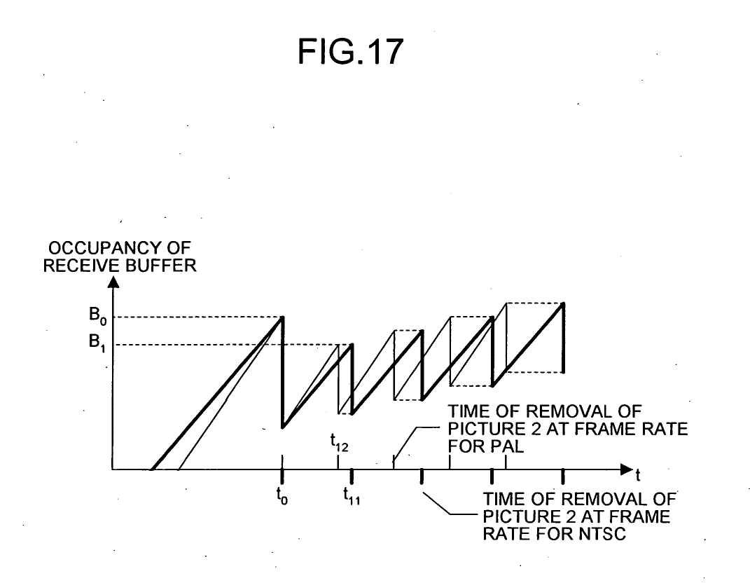

FIG. 17 is a graph of transition of the buffer occupancy at the frame rates in PAL and NTSC at rendering of coded moving picture data generated by the moving picture coding apparatus according to the second modification. As shown in FIG. 17, even when the removal time varies according to the difference in the frame rates, the amount of information to be removed is same and the maximum value and the minimum value of the buffer occupancy match between two frame rates.

In the actual process, however, the values pal_cpb_occupancy(k) and ntsc_cpb_occupancy(k) are integers, and there can be errors due to counting up and down, i.e., there can be an error smaller than one bit at the maximum. Hereinbelow this state is described as a “match with an error smaller than one bit.”

When the ratio of frame rates and the ratio of bit rates are made equal and one bit margin is provided for the coded picture buffer, even when the rate control is performed based on CBR, the moving picture coding apparatus can generate the coded moving picture data through the occupancy adding unit, the occupancy subtracting unit, the coded picture buffer, and the amount-of-code condition deriving unit that correspond only with one frame rate as shown in FIG. 6.

Hence, when the ratio of the plural employable frame rates for rendering and the ratio of the bit rates of the plural employable frame rates are made equal and one bit margin is provided for the coded picture buffer, the moving picture coding apparatus can generate the coded moving picture data which does not cause underflow nor overflow at the target frame rate even if the rate control is based on CBR simply by generating the coded moving picture data so as not cause underflow nor overflow at one frame rate. Thus, the workload of the coding process by the moving picture coding apparatus can be alleviated.

In the moving picture coding apparatus 100 according to the first embodiment, the removal time is set depending on the variation in frame rate when the frame rate is variable as the frame rate for rendering in NTSC. A moving picture coding apparatus with a similar structure as the moving picture coding apparatus of the first embodiment may set the average removal time for the variable frame rate as in the second or the third embodiment to subtract the generated bit.

In a modification described below, a moving picture coding apparatus includes the same structure as the moving picture coding apparatus of the first embodiment and the difference calculating unit. The process of rate control with CBR by the moving picture coding apparatus according to the modification is described. First, when the difference between the removal time at the variable frame rate and the removal time at the variation-averaged frame rate, which is an average of variable frame rate, takes a negative value, the coded moving picture data must be conditioned as to prevent the underflow as in the moving picture coding apparatus of the third embodiment. Here, underflow can be prevented similarly to the third embodiment, when a margin larger than the maximum value of the difference is taken from the lower limit of the coded picture buffer.

On the other hand, when the rate control is based on CBR, the control for the prevention of overflow is also necessary. Then, the case where the difference in the removal time at the variable frame rate and the removal time at the variation-averaged frame rate takes a positive value needs to be taken into account at the coding.

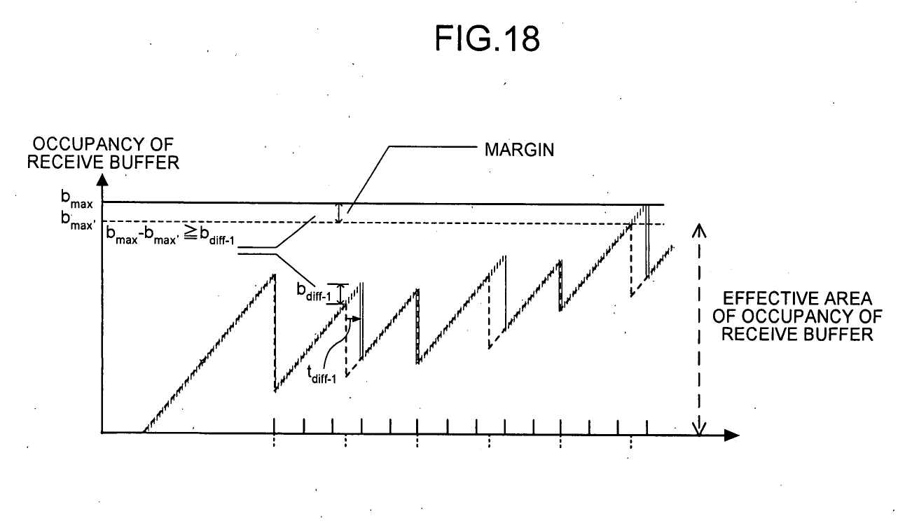

FIG. 18 is a graph of difference in transition of buffer occupancy caused by the difference in the removal time when the difference between the removal time at the variation-averaged frame rate and the frame rate for rendering in NTSC takes a positive value.

The difference in the removal time at the variation-averaged frame rate and the frame rate for rendering in NTSC is represented by t_{diff}_{_{—}}₁ and the difference in the buffer occupancy at t_{diff}_{_{—}}₁ is represented as b_{diff}_{_{—}}₁. When the maximum value bₘₐₓ, is set with a predetermined margin from the upper limit of the receive buffer, if the relation bₘₐₓ−b_{max′}≧b_{diff}_{_{—}}₁ holds, the overflow does not occur.

Thus, the moving picture coding apparatus of the modification sets the condition of generated bit using the maximum value bₘₐₓ, with a larger margin than the maximum value of the calculated difference provided by the difference calculating unit in the NTSC condition deriving unit when the difference takes a positive value, whereas sets the condition of generated bit using the minimum value bₘᵢₙ with a larger margin than the calculated difference provided by the difference calculating unit similarly to the third embodiment when the difference takes a negative value. Further, when the difference takes both positive and negative values, both of the maximum value bₘₐₓ, with a larger margin than the maximum value of difference and the minimum value bₘᵢₙ with a larger margin than the maximum value of difference are employed in the derivation of the condition of generated bit.

The modification does not intend to limit the variable frame rate to the frame rate for rendering in NTSC.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A moving picture coding apparatus for coding moving picture information based on an occupancy of a coded picture storing area in which a renderer temporarily stores coded moving picture information received at rendering of the coded moving picture information at a frame rate, the moving picture coding apparatus comprising:
a storing unit that stores the occupancy of the coded picture storing area;
a modifying unit that modifies the occupancy based on an amount of the coded moving picture information received at the coded picture storing area at rendering, and an amount of image data of the coded moving picture information for each image unit displayed at rendering;
a deriving unit that derives a condition for the amount of the image data to allow modification by the modifying unit at next rendering for each image unit based on a modified occupancy;
a setting unit that sets an optimal coding condition of the moving picture information to be coded that satisfies the condition for the amount of the image data; and
a coding unit that codes the moving picture information according to the optimal coding condition.

2. The moving picture coding apparatus according to claim 1, wherein
the storing unit includes a first storing unit and a second storing unit,
the modifying unit includes a first modifying unit and a second modifying unit,
the deriving unit includes a first deriving unit and a second deriving unit,
the first storing unit, the first modifying unit, and the first deriving unit are provided for rendering the coded image information at a first frame rate,
the second storing unit, the second modifying unit, and the second deriving unit are provided for rendering the coded image information at a second frame rate, and
the setting unit sets an optimal coding condition of the moving picture information to be coded that satisfies conditions for the amount of the image data derived for respective frame rates.

3. The moving picture coding apparatus according to claim 2, wherein
the modifying unit includes
an adding unit that adds an amount of the received coded moving picture information received by the coded picture storing area according to a bit rate at rendering of the coded moving picture information at a corresponding frame rate to stored occupancy; and
a subtracting unit that subtracts from the stored occupancy, the amount of the image data for each image unit displayed at rendering of the coded moving picture information generated from the moving picture information, at a timing of removal of the coded moving picture information at rendering at the corresponding frame rate.

4. The moving picture coding apparatus according to claim 3, wherein
the deriving unit derives the condition for the amount of the image data based on an upper limit which is a maximum amount of the occupancy stored prior to the subtraction of the image data, and a lower limit which is a difference between the sum of the maximum value of the occupancy prior to the subtraction of the amount of the image data and the amount of received data to be added by the adding unit prior to a next subtraction, and an upper limit of an amount storable in the coded picture storing area.

5. The moving picture coding apparatus according to claim 1, wherein
the storing unit stores the occupancy of the coded picture storing area at rendering of the coded moving picture information at a selected frame rate among plural frame rates at which the coded moving picture information is renderable and where a ratio of the frame rates and a ratio of bit rates at rendering of the coded moving picture information at the selected frame rate are equal, and
the modifying unit modifies the occupancy based on the amount of received data and the amount of the image data at rendering of the coded moving picture information at the selected frame rate.

6. The moving picture coding apparatus according to claim 1, further comprising:
a selecting unit that selects a highest frame rate among the plural frame rates for rendering of the coded moving picture information, wherein
the storing unit stores the occupancy of the coded picture storing unit at rendering of the coded moving picture information at a selected frame rate, and
the deriving unit derives the condition of the amount of the image data at a next modification by the modifying unit for each image unit displayed at rendering of the coded moving picture information at the selected frame rate based on the occupancy after the modification.

7. The moving picture coding apparatus according to claim 6, wherein
the modifying unit includes:
an adding unit that adds the amount of received data of the coded picture storing area according to the bit rate at rendering at the selected frame rate to the stored occupancy; and
a subtracting unit that subtracts from the stored occupancy the amount of the image data displayed at rendering of the coded moving picture information generated from the moving picture information, at a timing of removal of the coded moving picture information at rendering at the selected frame rate.

8. The moving picture coding apparatus according to claim 7, wherein
the deriving unit derives the condition of the amount of the image data setting the maximum amount of the stored occupancy stored prior to the subtraction of the amount of the image data as an upper limit.

9. The moving picture coding apparatus according to claim 8, further comprising:
a difference calculating unit that calculates a difference between the stored occupancy and the occupancy at an actual rendering of the coded moving picture information caused by a difference in a timing of subtraction of the amount of the image data from the stored occupancy by the subtracting unit and a timing of removal of the coded moving picture information at the actual rendering of the coded moving picture information, and
the deriving unit derives the condition of the amount of the image data setting a difference between the stored occupancy stored prior to the subtraction of the amount of the image data and the difference calculated by the difference calculating unit as an upper limit.

10. The moving picture coding apparatus according to claim 9, wherein
the difference calculating unit calculates the difference between the stored occupancy and the occupancy at the actual rendering of the coded moving picture information caused by the difference in a timing of subtraction of the amount of the image data from the stored occupancy by the subtracting unit and a timing of removal of the coded moving picture information at an actual rendering of the coded moving picture information due to 3:2 pulldown for rendering in the frame rate for NTSC.

11. The moving picture coding apparatus according to claim 6, wherein
the selecting unit selects the highest frame rate which has a highest peak rate from the plural frame rates.

12. The moving picture coding apparatus according to claim 1, wherein
the coding unit secures a timing area where timing information for display of a rendered moving picture is stored of an amount larger than an amount of a largest timing information among plural pieces of timing information corresponding to the plural frame rates, stores timing information corresponding to one of the frame rate, and performs zero-stuffing on an unused area.

13. The moving picture coding apparatus according to claim 1, wherein
the coding unit further stores plural pieces of timing information for a display of a rendered moving picture corresponding to respective frame rates for rendering of the coded moving picture information.

14. The moving picture coding apparatus according to claim 1, wherein
the coding unit codes the moving picture information with H.264 according to the optimal coding condition.

15. A coded moving picture editing apparatus, comprising:
an inputting unit that receives an input of coded moving picture information, the coded moving picture information being coded according to an optimal coding condition which satisfies a condition on an amount of image data of the coded moving picture information necessary for a display of the image unit at rendering and derived for each of plural frame rates for rendering, and the coded moving picture information including timing information for a display of each image unit at rendering at one of the plural frame rates;
a determining unit that determines the frame rate among the plural frame rates other than the frame rate corresponding to the timing information in the coded moving picture information; and
a modifying unit that modifies the timing information in the coded moving picture information to the timing information of the determined frame rate.

16. The coded moving picture editing apparatus according to claim 15, further comprising:
an overlay picture modifying unit that modifies a timing of display of an overlay picture so that the overlay picture is displayed in synchronization at rendering of the moving picture information whose timing information is modified;
an audio selecting unit that selects appropriate audio data for the moving picture information whose timing information is modified; and
a multiplexing unit that multiplexes the moving picture information, the overlay picture with modified timing, and the selected audio data.

17. Moving picture data comprising:
a structure including identification information for each of plural frame rates for rendering;
a structure including moving picture information coded according to an optimal coding condition which satisfies a condition of an amount of image data of the moving picture information which is derived for each image unit displayed at rendering and indicates a condition for a necessary amount of the image data for the display of each image unit at a frame rate; and
a structure including timing information for each frame rate for display of the moving picture information for each image unit at rendering.
